(19) United States
(12) Patent Application Publication
(10) Pub. No.: US 2023/0049978 A1
(43) Pub. Date: Feb. 16, 2023

(54) METHOD AND DEVICE IN UE AND BASE STATION FOR WIRELESS COMMUNICATION

(71) Applicants: Keying WU, SHANGHAI (CN); Xiaobo ZHANG, SHANGHAI (CN)

(72) Inventors: Keying WU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/975,622

(22) Filed: Oct. 28, 2022

Related U.S. Application Data
(63) Continuation of application No. PCT/CN2021/094354, filed on May 18, 2021.

(30) Foreign Application Priority Data
May 20, 2020 (CN) 202010428589.0
Jun. 17, 2020 (CN) 202010551430.8

(51) Int. Cl. H04L 5/00; H04W 72/04

(52) U.S. Cl. CPC H04L 5/0053; H04W 72/0446

(57) ABSTRACT

Disclosure provides a method and a device in a UE and a base station for wireless communication. A first node receives a first signaling and a second signaling, and transmits K signals in K air interface resource blocks respectively. The first signaling is used for determining a first air interface resource block and a first bit block, and the second signaling is used for determining K air interface resource blocks; the first air interface resource block and the K air interface resource blocks are overlapping in time domain; the K signals all carry a second bit block; a first signal subset among the K signals is spatially correlated to a first reference signal, and a second signal subset is spatially correlated to a second reference signal. The above method improves the reliability of transmission of uplink control information transmitted on the uplink physical layer data channel.

### CROSS REFERENCE TO RELATED APPLICATIONS

This application is a continuation of International Application No. PCT/CN2021/094354, filed May 18, 2021, which claims the priority benefit of Chinese Patent Application No. 202010428589.0, filed on May 20, 2020, and claims the priority benefit of Chinese Patent Application No. 202010551430.8, filed on Jun. 17, 2020 the full disclosure of which is incorporated herein by reference.

### BACKGROUND

### Technical Field

The disclosure relates to transmission methods and devices in wireless communication systems, and in particular to a transmission method and device for a radio signal in a wireless communication system supporting a cellular network.

### Related Art

Multiantenna technology is a key technology in 3rd Generation Partner Project (3GPP) Long-Term Evolution (LTE) systems and New Radio (NR) systems, which obtains an additional degree of spatial freedom through configuring multiple antennas at a communication node, for example, at a base station or User Equipment (UE). The multiple antennas form a beam through beamforming, the beam pointing at a specific direction to improve the quality of communication. When multiple antennas belong to multiple Transmitter Receiver Points (TRPs)/panels, an additional diversity gain can be obtained by means of the spatial diversity between different TRPs/panels. In NR R16, transmissions based on multiple TRPs are used for improving the reliability of transmission of a downlink physical layer data channel.

Compared with conventional 3GPP LTE systems, NR systems support more diversified application scenarios, for example, enhanced Mobile BroadBand (eMBB), Ultra-Reliable and Low Latency Communications (URLLC) and massive Machine-Type Communications (mMTC). Compared with other application scenarios, the URLLC has higher demand on the reliability and delay of transmission and the distinction might reach several magnitudes in some cases, which results in that different application scenarios have different requirements in the design of physical layer data channel and physical layer control channel. In NR R15, repeated transmission is used for improving the reliability of transmission of URLLC. NR R16 introduces the repeated transmission based on multi-TRP, further enhancing the reliability of transmission of URLLC.

### SUMMARY

In NR R17 and subsequent releases, multi-TRP/panel based transmission schemes will continuously evolve, and one important aspect includes enhancing an uplink physical layer data channel Similar to a downlink physical layer data channel, the reliability of transmission of the uplink physical layer data channel may be improved through a repeated transmission on beams directing at different TRPs/panels.

In conventional LTE systems, when uplink control information and uplink data of a UE collide in time domain, the uplink control information might be transmitted on an uplink physical layer data channel together with the data. When the uplink physical layer data channel is repeatedly transmitted by different beams, which of the repeated transmissions the uplink control information should be transmitted in is a problem to be solved. In view of the above problem, the disclosure provides a solution. It should be noted that although the above description takes the multi-TRP/panel transmission scenario as an example, the disclosure is also applicable to other scenarios, for example, single-TRP/panel transmission, carrier aggregation, or V2X communication scenarios, and achieves technical effects similar to those in the multi-TRP/panel transmission scenario. In addition, the adoption of a unified solution by different scenarios (including, but not limited to, multi-TRP/panel transmission, single-TRP/panel transmission, carrier aggregation and V2X) helps reduce the complexity and cost of hardware.

In NR R17 and subsequent releases, the performance of the URLLC will be further enhanced, and one important means is to provide a more correct channel quality feedback for the URLLC. In order to improve the correctness of the channel quality feedback, quick feedback is one important means, which can reduce the error caused by channel time varying. How to further improve the speed of channel feedback on the basis of the existing system is a problem to be solved. In view of the above problems, the disclosure provides a solution. It should be noted that although the above description takes the URLLC scenario as an example, the disclosure is also applicable to other scenarios such as eMBB and mMTC and achieves technical effects similar to those in the URLLC scenario. In addition, the adoption of a unified solution by different scenarios (including, but not limited to, URLLC, eMBB and mMTC) helps reduce the complexity and cost of hardware. The embodiments of the first node in the disclosure and the characteristics of the embodiments may be applied to the second node if no conflict is incurred, and vice versa. The embodiments of the disclosure and the characteristics of the embodiments may be arbitrarily combined mutually.

The disclosure provides a method in a first node for wireless communication, wherein the method includes:

receiving a first signaling, the first signaling being used for determining a first air interface resource block and a first bit block;

receiving a second signaling, the second signaling being used for determining K air interface resource blocks, and the K being a positive integer greater than 2; and

transmitting K signals in the K air interface resource blocks respectively.

Herein, the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located (QCLed); only a first signal and a second signal among the K signals carry the first bit block; the first signal is a first signal in the first signal subset, and the second signal is a first signal in the second signal subset.

In one embodiment, the problem to be solved by the disclosure includes: when an uplink physical layer data channel is repeatedly transmitted by different beams, which of the repeated transmissions the uplink control information should be transmitted in.

In one embodiment, the above method is characterized in that: the K signals include K repeated transmissions of the second bit block, the first bit block carries uplink control information, and the first bit block is transmitted in two repeated transmissions by different beams among the K repeated transmissions.

In one embodiment, the advantages of the above method include: the reliability of transmission of the uplink control information is improved.

According to one aspect of the disclosure, the method includes:

receiving a third signal.

Herein, the first signaling is used for determining configuration information of the third signal, and the third signal is used for determining the first bit block.

According to one aspect of the disclosure, the first signal includes a first sub-signal, and the first sub-signal carries the first bit block; the second signal includes a second sub-signal, and the second sub-signal carries the first bit block; and a number of resource elements occupied by the first sub-signal is equal to a number of resource elements occupied by the second sub-signal.

In one embodiment, the advantages of the above method include: the calculation for the number of resource elements occupied by the uplink control information on the uplink physical layer data channel is simplified.

According to one aspect of the disclosure, the first signal includes a first sub-signal, and the first sub-signal carries the first bit block; the second signal includes a second sub-signal, and the second sub-signal carries the first bit block; the first reference signal is used for determining a first offset, and the second reference signal is used for determining a second offset; and the first offset and the second offset are used for determining a number of resource elements occupied by the first sub-signal and a number of resource elements occupied by the second sub-signal respectively.

In one embodiment, the advantages of the above method include: the numbers of resource elements occupied by the uplink control information in the two repeated transmissions are adjusted respectively according to the qualities of channels experienced by the two repeated transmissions, which guarantees the reliability of transmission of the uplink control information and avoids the waste of resources.

According to one aspect of the disclosure, the first signal includes a first sub-signal, and the first sub-signal carries the first bit block; the second signal includes a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

According to one aspect of the disclosure, the method includes:

transmitting a third signal subset in a first air interface resource block subset.

Herein, any one signal in the third signal subset carries the second bit block, the second signaling is used for determining K0 air interface resource blocks, the K0 air interface resource blocks include the K air interface resource blocks and the first air interface resource block subset, and the K0 is a positive integer greater than 3; and the first air interface resource block subset is orthogonal to the first air interface resource block in time domain.

According to one aspect of the disclosure, a time interval between an earliest air interface resource block among the K air interface resource blocks and the first signaling is not less than a first interval.

According to one aspect of the disclosure, the first node is a UE.

According to one aspect of the disclosure, the first node is a relay node.

The disclosure provides a method in a second node for wireless communication, wherein the method includes:

transmitting a first signaling, the first signaling being used for determining a first air interface resource block and a first bit block;

transmitting a second signaling, the second signaling being used for determining K air interface resource blocks, and the K being a positive integer greater than 2; and

receiving K signals in the K air interface resource blocks respectively.

Herein, the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

According to one aspect of the disclosure, the method includes:

transmitting a third signal.

Herein, the first signaling is used for determining configuration information of the third signal, and the third signal is used for determining the first bit block.

According to one aspect of the disclosure, the first signal includes a first sub-signal, and the first sub-signal carries the first bit block; the second signal includes a second sub-signal, and the second sub-signal carries the first bit block; and a number of resource elements occupied by the first sub-signal is equal to a number of resource elements occupied by the second sub-signal.

According to one aspect of the disclosure, the first signal includes a first sub-signal, and the first sub-signal carries the first bit block; the second signal includes a second sub-signal, and the second sub-signal carries the first bit block; the first reference signal is used for determining a first offset, and the second reference signal is used for determining a second offset; and the first offset and the second offset are used for determining a number of resource elements occupied by the first sub-signal and a number of resource elements occupied by the second sub-signal respectively.

According to one aspect of the disclosure, the first signal includes a first sub-signal, and the first sub-signal carries the first bit block; the second signal includes a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

According to one aspect of the disclosure, the method includes:

receiving a third signal subset in a first air interface resource block subset.

Herein, any one signal in the third signal subset carries the second bit block, the second signaling is used for determining K0 air interface resource blocks, the K0 air interface resource blocks include the K air interface resource blocks and the first air interface resource block subset, and the K0 is a positive integer greater than 3; and the first air interface resource block subset is orthogonal to the first air interface resource block in time domain.

According to one aspect of the disclosure, a time interval between an earliest air interface resource block among the K air interface resource blocks and the first signaling is not less than a first interval.

According to one aspect of the disclosure, the second node is a base station.

According to one aspect of the disclosure, the second node is a UE.

According to one aspect of the disclosure, the second node is a relay node.

The disclosure provides a first node for wireless communication, wherein the first node includes:

a first receiver, to receive a first signaling and a second signaling, the first signaling being used for determining a first air interface resource block and a first bit block, the second signaling being used for determining K air interface resource blocks, and the K being a positive integer greater than 2; and

a first transmitter, to transmit K signals in the K air interface resource blocks respectively.

Herein, the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

The disclosure provides a second node for wireless communication, wherein the second node includes:

a second transmitter, to transmit a first signaling and a second signaling, the first signaling being used for determining a first air interface resource block and a first bit block, the second signaling being used for determining K air interface resource blocks, and the K being a positive integer greater than 2; and

a second receiver, to receive K signals in the K air interface resource blocks respectively.

Herein, the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, compared with conventional schemes, the disclosure has the following advantages.

The space diversity and transmission reliability of the uplink control information transmitted on the uplink physical layer data channel are improved.

The mechanism of repeated transmission is simplified when the uplink control information is repeatedly transmitted.

The disclosure provides a method in a first node for wireless communication, wherein the method includes:

receiving a first signal;

receiving a first reference signal group in a first reference signal resource group; and

transmitting a first information block.

Herein, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the problem to be solved by the disclosure includes: how to improve the speed of channel feedback. The above method adds a limit to the rank number that the channel feedback can select, thereby reducing the complexity of channel estimation and solving this problem.

In one embodiment, the above method is characterized in that: the first channel quality indicates: a highest CQI at which the first bit block can be received by the first node with a transmission block error rate not exceeding the first threshold, when the first bit block is transmitted in the first reference resource block and a number of layers of a radio signal carrying the first bit block is equal to the first rank number.

In one embodiment, the above method has the following benefits: the complexity of channel estimation is reduced, the speed and accuracy of channel feedback are improved, and the reliability of data transmission is increased.

According to one aspect of the disclosure, the method includes:

receiving a first signaling.

Herein, the first signaling includes scheduling information of the first signal, and the first signaling triggers the transmission of the first information block; the first signaling indicates the number of layers of the first signal.

According to one aspect of the disclosure, the first signal is spatially correlated to a first reference signal subgroup, the first reference signal subgroup is a subset of the first reference signal group; and the first channel quality is calculated under the condition of the first reference signal subgroup.

According to one aspect of the disclosure, the first reference signal subgroup includes M reference signals, and the M is a positive integer greater than 1; the first reference resource block includes M reference resource subblocks, and the M reference resource subblocks are one-to-one corresponding to the M reference signals.

In one embodiment, the problem to be solved by the above method includes: how to improve the feedback precision of channel quality, when the multi-TRP based repeated transmission is used for transmitting a data channel. The above method solves this problem by enabling signals transmitted in different reference resource subblocks to be spatially correlated to different reference signals respectively.

According to one aspect of the disclosure, the number of layers of the first signal is used for determining K candidate rank numbers, and the K is a positive integer greater than 1; the first rank number is one of the K candidate rank numbers.

According to one aspect of the disclosure, the method includes:

receiving a second information block.

Herein, the second information block include a first report configuration, the first report configuration indicates a first report metric set and the first reference signal group, and the first report metric set is used for determining the content of the first information block.

According to one aspect of the disclosure, the number of layers of the first signal is used for determining the first rank number when and only when the second condition set is met.

In one embodiment, the above method has the following benefits: a flexible switch is implemented between the limited rank number and the available rank number that the user can freely select, which meets the requirements of channel feedback in different application scenarios.

According to one aspect of the disclosure, the first node is a UE.

According to one aspect of the disclosure, the first node is a relay node.

The disclosure provides a method in a second node for wireless communication, wherein the method includes:

transmitting a first signal;

transmitting a first reference signal group in a first reference signal resource group; and

receiving a first information block.

Herein, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the transmitter of the first information block with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

According to one aspect of the disclosure, the method includes:

transmitting a first signaling.

Herein, the first signaling includes scheduling information of the first signal, and the first signaling triggers the transmission of the first information block; the first signaling indicates the number of layers of the first signal.

According to one aspect of the disclosure, the first signal is spatially correlated to a first reference signal subgroup, the first reference signal subgroup is a subset of the first reference signal group; and the first channel quality is calculated under the condition of the first reference signal subgroup.

According to one aspect of the disclosure, the first reference signal subgroup includes M reference signals, and the M is a positive integer greater than 1; the first reference resource block includes M reference resource subblocks, and the M reference resource subblocks are one-to-one corresponding to the M reference signals.

According to one aspect of the disclosure, the number of layers of the first signal is used for determining K candidate rank numbers, and the K is a positive integer greater than 1; the first rank number is one of the K candidate rank numbers.

According to one aspect of the disclosure, the method includes:

transmitting a second information block.

Herein, the second information block include a first report configuration, the first report configuration indicates a first report metric set and the first reference signal group, and the first report metric set is used for determining the content of the first information block.

According to one aspect of the disclosure, the number of layers of the first signal is used for determining the first rank number when and only when the second condition set is met.

According to one aspect of the disclosure, the second node is a base station.

According to one aspect of the disclosure, the second node is a UE.

According to one aspect of the disclosure, the second node is relay node.

The disclosure provides a first node for wireless communication, wherein the first node includes:

a first receiver, to receive a first signal, and receive a first reference signal group in a first reference signal resource group; and

a first transmitter, to transmit a first information block.

Herein, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

The disclosure provides a second node for wireless communication, wherein the second node includes:

a second transmitter, to transmit a first signal, and transmit a first reference signal group in a first reference signal resource group; and

a second receiver, to receive a first information block.

Herein, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the transmitter of the first information block with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, compared with conventional schemes, the disclosure has the following advantage.

The complexity of channel estimation is reduced, the speed and accuracy of channel feedback are improved, and the reliability of data transmission is increased.

The feedback precision of channel quality is improved when the multi-TRP based repeated transmission is applied to a data channel.

A flexible switch is supported between the limited rank number and the available rank number that the user can freely select, which meets the requirements of channel feedback in different application scenarios.

### BRIEF DESCRIPTION OF THE DRAWINGS

Other features, purposes and advantages of the disclosure will become more apparent from the detailed description of non-restrictive embodiments taken in conjunction with the following drawings.

FIG. 1 is a flowchart of a first signaling, a second signaling and K signals according to one embodiment of the disclosure.

FIG. 2 is a diagram illustrating a network architecture according to one embodiment of the disclosure.

FIG. 3 is a diagram illustrating an embodiment of a radio protocol architecture of a user plane and a control plane according to one embodiment of the disclosure.

FIG. 4 is a diagram illustrating a first communication equipment and a second communication equipment according to one embodiment of the disclosure.

FIG. 5 is a flowchart of transmission according to one embodiment of the disclosure.

FIG. 6 is a diagram of a scenario in which a second signaling is used for determining K air interface resource blocks according to one embodiment of the disclosure.

FIG. 7 is a diagram of a scenario in which a second signaling is used for determining K air interface resource blocks according to one embodiment of the disclosure.

FIG. 8 is a diagram of K air interface resource blocks according to one embodiment of the disclosure.

FIG. 9 is a diagram of a scenario in which a given signal is spatially correlated to a given reference signal according to one embodiment of the disclosure.

FIG. 10 is a diagram of a scenario in which a third signal is used for determining a first bit block according to one embodiment of the disclosure.

FIG. 11 is a diagram of a scenario in which a third signal is used for determining a first bit block according to one embodiment of the disclosure.

FIG. 12 is a diagram of a first signal, a first sub-signal, a second signal and a second sub-signal according to one embodiment of the disclosure.

FIG. 13 is a diagram of a number of resource elements occupied by a first sub-signal and a number of resource elements occupied by a second sub-signal according to one embodiment of the disclosure.

FIG. 14 is a diagram of a scenario in which a first reference signal is used for determining a first offset and a second reference signal is used for determining a second offset according to one embodiment of the disclosure.

FIG. 15 is a diagram of a number of resource elements occupied by a first sub-signal according to one embodiment of the disclosure.

FIG. 16 is a diagram of a number of resource elements occupied by a second sub-signal according to one embodiment of the disclosure.

FIG. 17 is a diagram of a scenario in which a second signaling indicates a target integer according to one embodiment of the disclosure.

FIG. 18 is a diagram of a scenario in which a target integer is used for determining a number of resource elements occupied by a first sub-signal according to one embodiment of the disclosure.

FIG. 19 is a diagram of a scenario in which a target integer is used for determining a number of resource elements occupied by a second sub-signal according to one embodiment of the disclosure.

FIG. 20 is a diagram of a first air interface resource block subset, K air interface resource blocks and K0 air interface resource blocks according to one embodiment of the disclosure.

FIG. 21 is a diagram of a scenario in which a second signaling is used for determining K0 air interface resource blocks according to one embodiment of the disclosure.

FIG. 22 is a diagram of a time interval between an earliest air interface resource block among K air interface resource blocks and a first signaling according to one embodiment of the disclosure.

FIG. 23 is a structure block diagram of a processing device in a first node according to one embodiment of the disclosure.

FIG. 24 is a structure block diagram of a processing device in a second node according to one embodiment of the disclosure.

FIG. 25 is a flowchart of a first signal, a first reference signal group and a first information block according to one embodiment of the disclosure.

FIG. 26 is a flowchart of transmission according to one embodiment of the disclosure.

FIG. 27 is a diagram of a scenario in which a time domain position of a first reference resource block is associated to a time domain resource occupied by a first information block according to one embodiment of the disclosure.

FIG. 28 is a diagram of a first signaling according to one embodiment of the disclosure.

FIG. 29 is a diagram of a scenario in which a first signal is spatially correlated to a first reference signal subgroup according to one embodiment of the disclosure.

FIG. 30 is a diagram of a scenario in which a first channel quality is calculated under the condition of a first reference signal subgroup according to one embodiment of the disclosure.

FIG. 31 is a diagram of a scenario in which a given signal is spatially correlated to a given reference signal according to one embodiment of the disclosure.

FIG. 32 is a diagram of M reference resource subblocks and M reference signals according to one embodiment of the disclosure.

FIG. 33 is a diagram of a scenario in which a number of layers of a first signal is used for determining K candidate rank numbers according to one embodiment of the disclosure.

FIG. 34 is a diagram of a second information block according to one embodiment of the disclosure.

FIG. 35 is a diagram of a relationship between a second condition set and a first rank number according to one embodiment of the disclosure.

FIG. 36 is a structure block diagram of a processing device in a first node according to one embodiment of the disclosure.

FIG. 37 is a structure block diagram of a processing device in a second node according to one embodiment of the disclosure.

### DESCRIPTION OF THE EMBODIMENTS

The technical scheme of the disclosure is described below in further detail in conjunction with the drawings. It should be noted that the embodiments in the disclosure and the characteristics of the embodiments may be mutually combined arbitrarily if no conflict is incurred.

### Embodiment 1

Embodiment 1 illustrates a flowchart of a first signaling, a second signaling and K signals according to one embodiment of the disclosure, as shown in FIG. 1. In 100 in FIG. 1, each box represents one step. In particular, the order of the steps in the box does not represent a specific precedence relationship in time between the steps.

In Embodiment 1, the first node in the disclosure receives a first signaling in S101, receives a second signaling in S102, and transmits K signals in K air interface resource blocks respectively in S103. Herein, the first signaling is used for determining a first air interface resource block and a first bit block; the second signaling is used for determining K air interface resource blocks, and the K being a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the first signaling includes a physical layer signaling.

In one embodiment, the first signaling includes a dynamic signaling.

In one embodiment, the first signaling includes a Layer 1 (L1) signaling.

In one embodiment, the first signaling includes a Layer 1 (L1) control signaling.

In one embodiment, the first signaling includes Downlink Control Information (DCI).

In one embodiment, the first signaling includes one or more fields in one DCI.

In one embodiment, the first signaling includes one or more fields in one piece of Sidelink Control Information (SCI).

In one embodiment, the first signaling includes a DCI for downlink grant.

In one embodiment, the first signaling includes a DCI for uplink grant.

In one embodiment, the first signaling includes a DCI for Semi-Persistent Scheduling (SPS) release.

In one embodiment, the first signaling includes a higher layer signaling.

In one embodiment, the first signaling includes a Radio Resource Control (RRC) signaling.

In one embodiment, the first signaling includes a Medium Access Control layer Control Element (MAC CE) signaling.

In one embodiment, the second signaling includes a physical layer signaling.

In one embodiment, the second signaling includes a dynamic signaling.

In one embodiment, the second signaling includes a Layer 1 (L1) signaling.

In one embodiment, the second signaling includes a Layer 1 (L1) control signaling.

In one embodiment, the second signaling includes a DCI.

In one embodiment, the second signaling includes one or more fields in one DCI.

In one embodiment, the second signaling includes one or more fields in one SCI.

In one embodiment, the second signaling includes a DCI for downlink grant.

In one embodiment, the second signaling includes a higher layer signaling.

In one embodiment, the second signaling includes an RRC signaling.

In one embodiment, the second signaling includes an MAC CE signaling.

In one embodiment, the first signaling and the second signaling belong to one same serving cell in frequency domain.

In one embodiment, the first signaling and the second signaling belong to different serving cells in frequency domain.

In one embodiment, a start time of the first signaling is earlier than a start time of the second signaling.

In one embodiment, a start time of the first signaling is later than a start time of the second signaling.

In one embodiment, an end time of the first signaling is earlier than an end time of the second signaling.

In one embodiment, an end time of the first signaling is later than an end time of the second signaling.

In one embodiment, an end time of the first signaling is earlier than a start time of the second signaling.

In one embodiment, a start time of the first signaling is later than an end time of the second signaling.

In one embodiment, the second signaling indicates scheduling information of each signal among the K signals.

In one embodiment, the scheduling information includes one or more of time domain resources, frequency domain resources, a Modulation and Coding Scheme (MCS), a DeModulation Reference Signals (DMRS) port, a Hybrid Automatic Repeat reQuest (HARQ) process number, a Redundancy Version (RV) or a New Data Indicator (NDI).

In one embodiment, the second signaling indicates explicitly scheduling information of one signal among the K signals.

In one embodiment, the second signaling indicates implicitly scheduling information of one signal among the K signals.

In one embodiment, the K signals include a given signal, the second signaling indicates explicitly part scheduling information of the given signal and indicates implicitly the other part scheduling information of the given signal.

In one embodiment, the second signaling indicates explicitly scheduling information of a first signal among the K signals.

In one embodiment, the second signaling indicates implicitly part or all scheduling information of any one of the K signals other than the first signal.

In one embodiment, the K signals correspond to a same MCS.

In one embodiment, the K signals correspond to a same HARQ process number.

In one embodiment, the K signals correspond to a same NDI.

In one embodiment, two of the K signals correspond to a same RV.

In one embodiment, two of the K signals correspond to different RVs.

In one embodiment, the K is not less than 4.

In one embodiment, the K is equal to 3.

In one embodiment, the first signaling indicates the first air interface resource block.

In one embodiment, the first signaling indicates explicitly the first air interface resource block.

In one embodiment, the first signaling includes a first field, and the first field in the first signaling indicates the first air interface resource block; and the first field includes a positive integer number of bits.

In one embodiment, the first field includes 3 bits.

In one embodiment, the first field includes one field in one DCI.

In one embodiment, the first field includes one field in one Information Element (IE).

In one embodiment, the first signaling indicates implicitly the first air interface resource block.

In one embodiment, other information indicated by the first signaling is used for deducing the first air interface resource block.

In one embodiment, time-frequency resources occupied by the first signaling are used for determining the first air interface resource block.

In one embodiment, a DCI format corresponding to the first signaling is used for determining the first air interface resource block.

In one embodiment, the first air interface resource block includes time domain resources and frequency domain resources.

In one embodiment, the first air interface resource block includes time domain resources, frequency domain resources and code domain resources.

In one embodiment, the first air interface resource block occupies a positive integer number (greater than 1) of resource elements in time-frequency domain.

In one embodiment, the first air interface resource block occupies a positive integer number of Physical Resource Blocks (PRBs) in frequency domain.

In one embodiment, the first air interface resource block occupies a positive integer number of multicarrier symbols in time domain.

In one embodiment, the first air interface resource block includes a Physical Uplink Control Channel (PUCCH) resource.

In one embodiment, the first air interface resource block includes a PUCCH resource set.

In one embodiment, the first air interface resource block is one PUCCH resource.

In one embodiment, the first air interface resource block is reserved for the first bit block.

In one embodiment, the first air interface resource block is reserved for transmission of the first bit block.

In one embodiment, the first air interface resource block is reserved for transmission of a radio signal carrying the first bit block.

In one embodiment, the first signaling is used for determining a number of bits included in the first bit block.

In one embodiment, the first signaling is used for determining a value of a bit included in the first bit block.

In one embodiment, the first bit block includes a positive integer number of bits.

In one embodiment, a number of bits included in the first bit block is greater than 1.

In one embodiment, a number of bits included in the first bit block is equal to 1.

In one embodiment, all bits in the first bit block are sequentially arranged.

In one embodiment, the first bit block includes Uplink Control Information (UCI).

In one embodiment, the first bit block includes a Hybrid Automatic Repeat reQuest-Acknowledgement (HARQ-ACK).

In one embodiment, the HARQ-ACK includes an ACK.

In one embodiment, the HARQ-ACK includes a Negative ACK (NACK).

In one embodiment, the first bit block includes Scheduling Request (SR) information.

In one embodiment, the first bit block includes Channel State Information (CSI) information.

In one embodiment, the first bit block includes a Cyclic Redundancy Check (CRC) bit.

In one embodiment, the first bit block includes a first bit subblock and a second bit subblock, the first bit subblock includes a UCI, and the second bit subblock is generated by a CRC bit block of the first bit subblock.

In one subembodiment, the second bit subblock is a CRC bit block of the first bit subblock.

In one subembodiment, the second bit subblock is a bit block obtained after a CRC bit block of the first bit subblock is scrambled.

In one embodiment, the second signaling indicates the K air interface resource blocks.

In one embodiment, the second signaling indicates explicitly the K.

In one embodiment, the K is configured through a higher layer parameter.

In one embodiment, the second signaling indicates explicitly time domain resources occupied by the K air interface resource blocks.

In one embodiment, the second signaling indicates implicitly time domain resources occupied by the K air interface resource blocks.

In one embodiment, the second signaling indicates explicitly frequency domain resources occupied by the K air interface resource blocks.

In one embodiment, the second signaling indicates implicitly frequency domain resources occupied by the K air interface resource blocks.

In one embodiment, information indicated by the second signaling is used for deducing time-frequency resources occupied by the K air interface resource blocks.

In one embodiment, the K signals include K baseband signals respectively.

In one embodiment, the K signals include K radio signals respectively.

In one embodiment, the K signals include K radio frequency signals respectively.

In one embodiment, the K signals include K repeated transmissions of the second bit block.

In one embodiment, the K signals include K repeated transmissions of the second bit block in time domain.

In one embodiment, any one of the K signals does not include a reference signal.

In one embodiment, any one of the K signals does not include a DMRS.

In one embodiment, any one of the K signals does not include a Phase-Tracking Reference Signal (PTRS).

In one embodiment, one of the K signals includes a DMRS.

In one embodiment, one of the K signals includes a PTRS.

In one embodiment, the second bit block includes a positive integer number (greater than 1) of bits.

In one embodiment, all bits in the second bit block are sequentially arranged.

In one embodiment, the second bit block includes one Transport Block (TB).

In one embodiment, the second bit block includes one Code Block (CB).

In one embodiment, the second bit block includes one Code Block Group (CBG).

In one embodiment, the phrase that a given signal carries a given bit block includes: the given signal is an output after the bits in the given bit block are processed in sequence through CRC attachment, code block segmentation, code block CRC attachment, channel coding, rate matching, concatenation, scrambling, modulation, layer mapping, precoding, resource element mapping, mapping from virtual to physical resource blocks, generation of multicarrier symbols, modulation and upconversion.

In one embodiment, the phrase that a given signal carries a given bit block includes: the given signal is an output after the bits in the given bit block are processed in sequence through CRC attachment, channel coding, rate matching, modulation, layer mapping, transform precoding, precoding, resource element mapping, mapping from virtual to physical resource blocks, generation of multicarrier symbols, modulation and upconversion.

In one embodiment, the phrase that a given signal carries a given bit block includes: the given bit block is used for generating the given signal.

In one embodiment, the given signal is any one of the K signals, and the given bit block is the second bit block.

In one embodiment, the given signal is the first signal or the second signal, and the given bit bock is the first bit block.

In one embodiment, the given signal is the first sub-signal or the second sub-signal, and the given bit bock is the first bit block.

In one embodiment, the given signal is the third signal, and the given bit block is the third bit block.

In one embodiment, the given signal is any one signal in the third signal subset, and the given bit block is the second bit block.

In one embodiment, the first reference signal includes a Channel State Information-Reference Signal (CSI-RS).

In one embodiment, the first reference signal includes a Synchronization Signal/physical broadcast channel Block (SSB).

In one embodiment, the first reference signal includes a Sounding Reference Signal (SRS).

In one embodiment, the second reference signal includes a CSI-RS.

In one embodiment, the second reference signal includes an SSB.

In one embodiment, the second reference signal includes an SRS.

In one embodiment, the second signaling indicates the first reference signal and the second reference signal.

In one embodiment, the second signaling includes a fifth field, the fifth field in the second signaling indicates the first reference signal and the second reference signal, and the fifth field includes a positive integer number (greater than 1) of bits.

In one embodiment, the second signaling indicates an SRS resource indicator (SRI) codepoint corresponding to the first reference signal and an SRI codepoint corresponding to the second reference signal.

In one embodiment, the second signaling indicates a Transmission Configuration Indicator (TCI) codepoint corresponding to the first reference signal and a TCI codepoint corresponding to the second reference signal.

In one embodiment, the first reference signal and the second reference signal correspond to a same SRI codepoint.

In one embodiment, the first reference signal and the second reference signal correspond to a same TCI codepoint.

In one embodiment, the QCLed includes Quasi-Co-Located.

In one embodiment, the QCLed includes Quasi-Co-Located and corresponds to a QCL-TypeA.

In one embodiment, the QCLed includes Quasi-Co-Located and corresponds to a QCL-TypeB.

In one embodiment, the QCLed includes Quasi-Co-Located and corresponds to a QCL-TypeC.

In one embodiment, the QCLed includes Quasi-Co-Located and corresponds to a QCL-TypeD.

In one embodiment, a DMRS of any one signal in the first signal subset is QCLed with the first reference signal.

In one embodiment, a DMRS of any one signal in the first signal subset is QCLed with the first reference signal and corresponds to a QCL-TypeD.

In one embodiment, a DMRS of any one signal in the second signal subset is QCLed with the second reference signal.

In one embodiment, a DMRS of any one signal in the second signal subset is QCLed with the second reference signal and corresponds to a QCL-TypeD.

In one embodiment, the first signal subset includes only one signal among the K signals.

In one embodiment, the first signal subset includes multiple signals among the K signals.

In one embodiment, any one signal in the first signal subset is one of the K signals.

In one embodiment, the second signal subset includes only one signal among the K signals.

In one embodiment, the second signal subset includes multiple signals among the K signals.

In one embodiment, any one signal in the second signal subset is one of the K signals.

In one embodiment, there is no signal among the K signals belonging to both the first signal subset and the second signal subset.

In one embodiment, a summation of a number of signals included in the first signal subset and a number of signals included in the second signal subset is equal to the K.

In one embodiment, a summation of a number of signals included in the first signal subset and a number of signals included in the second signal subset is less than the K.

In one embodiment, any one of the K signals other than the first signal and the second signal is uncorrelated to the first bit block.

In one embodiment, any one of the K signals other than the first signal and the second signal does not carry the first bit block.

In one embodiment, an end time of the first signal is not later than a start time of any one signal in the first signal subset other than the first signal.

In one embodiment, an end time of the second signal is not later than a start time of any one signal in the second signal subset other than the second signal.

In one embodiment, an end time of the first signal is not later than a start time of the second signal.

In one embodiment, a start time of the first signal is not earlier than an end time of the second signal.

In one embodiment, the first signal indicates a priority of the first bit block.

In one embodiment, one bit in the first signaling indicates a priority of the first bit block.

In one embodiment, a DCI format of the first signaling is used for determining a priority of the first bit block.

In one embodiment, the second signal indicates a priority of the second bit block.

In one embodiment, one bit in the second signaling indicates a priority of the second bit block.

In one embodiment, a DCI format of the second signaling is used for determining a priority of the second bit block.

In one embodiment, a priority of the first bit block corresponds to a priority index 0 or 1.

In one embodiment, a priority of the second bit block corresponds to a priority index 0 or 1.

In one embodiment, a priority index of the first bit block is greater than a priority index of the second bit block.

In one embodiment, a priority index of the first bit block is equal to a priority index of the second bit block.

In one embodiment, a priority index of the first bit block is less than a priority index of the second bit block.

In one embodiment, a priority of the first bit block is higher than a priority of the second bit block.

In one embodiment, a priority of the first bit block is lower than a priority of the second bit block.

In one embodiment, a priority of the first bit block is equal to a priority of the second bit block.

In one embodiment, the phrase that the first signaling is used for determining the first bit block includes: the first bit block indicates whether the first signaling is correctly received.

### Embodiment 2

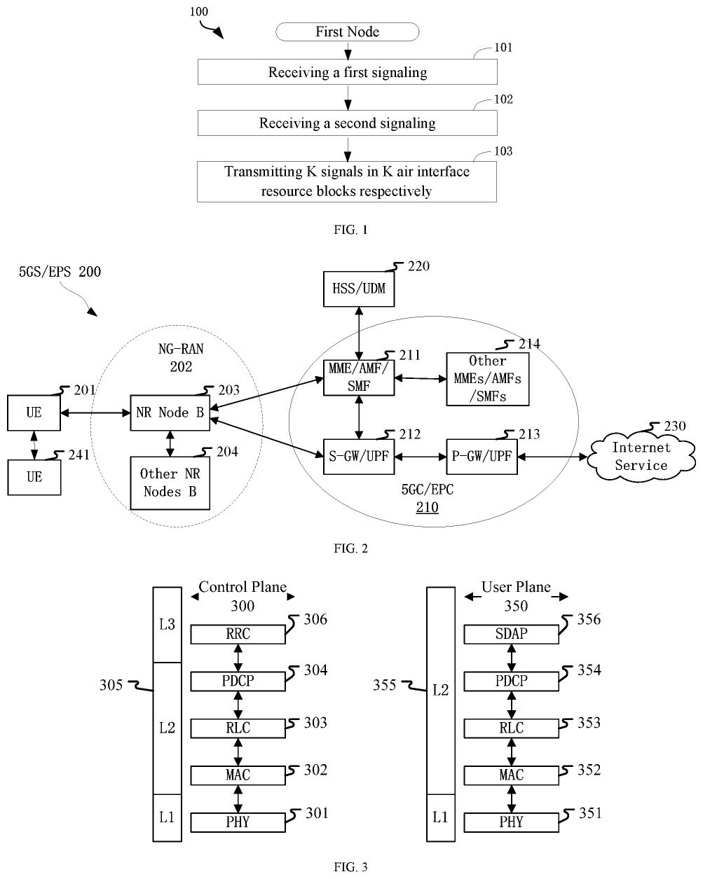

Embodiment 2 illustrates a diagram of a network architecture according to one embodiment of the disclosure, as shown in FIG. 2.

FIG. 2 illustrates a network architecture 200 of Long-Term Evolution (LTE), Long-Term Evolution Advanced (LTE-A) and future 5G systems. The network architecture 200 of the LTE, LTE-A and future 5G systems may be called an Evolved Packet System (EPS) 200. The 5G NR or LTE network architecture 200 may be called a 5G System (5GS)/Evolved Packet System (EPS) 200 or some other appropriate terms. The 5GS/EPS 200 may include one or more UEs 201, a UE 241 in sidelink communication with the UE 201, a Next Generation-Radio Access Network (NG-RAN) 202, an 5G-Core Network/Evolved Packet Core (5GC/EPC) 210, a Home Subscriber Server (HSS) 220, a Home Subscriber Server (HSS)/Unified Data Management (UDM) and an Internet service 230. The 5GS/EPS 200 may be interconnected with other access networks. For simple description, the entities/interfaces are not shown. As shown in FIG. 2, the 5GS/EPS 200 provides packet switching services. Those skilled in the art are easy to understand that various concepts presented throughout the disclosure can be extended to networks providing circuit switching services. The NG-RAN 202 includes an NR node B (gNB) 203 and other gNBs 204. The gNB 203 provides UE 201 oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Basic Service Set (BSS), an Extended Service Set (ESS), a TRP or some other appropriate terms. The gNB 203 provides an access point of the 5GC/EPC 210 for the UE 201. Examples of UE 201 include cellular phones, smart phones, Session Initiation Protocol (SIP) phones, laptop computers, Personal Digital Assistants (PDAs), satellite radios, non-terrestrial base statin communications, satellite mobile communications, Global Positioning Systems (GPSs), multimedia devices, video devices, digital audio player (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art may also call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 includes a Mobility Management Entity/Authentication Management Field/Session Management Function (MME/AMF/SMF) 211, other MMEs/AMFs/SMFs 214, a Service Gateway (S-GW)/User Plane Function (UPF) 212 and a Packet Data Network Gateway/UPF (P-GW/UPF) 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet service 230. The Internet service 230 includes IP services corresponding to operators, specifically including internet, intranet, IP Multimedia Subsystems (IP IMSs) and PS Streaming Services (PSSs).

In one embodiment, the first node in the disclosure includes the UE 201.

In one embodiment, the first node in the disclosure includes the UE 241.

In one embodiment, the second node in the disclosure includes the gNB 203.

In one embodiment, the second node in the disclosure includes the UE 241.

In one embodiment, a wireless link between the UE 201 and the gNB 203 is a cellular link.

In one embodiment, a wireless link between the UE 201 and the UE 241 is a sidelink

In one embodiment, a transmitter of the first signaling in the disclosure includes the gNB 203.

In one embodiment, a receiver of the first signaling in the disclosure includes the UE 201.

In one embodiment, a transmitter of the second signaling in the disclosure includes the gNB 203.

In one embodiment, a receiver of the second signaling in the disclosure includes the UE 201.

In one embodiment, a transmitter of the K signals in the disclosure includes the UE 201.

In one embodiment, a receiver of the K signals in the disclosure includes the gNB 203.

In one embodiment, a transmitter of the first signal in the disclosure includes the gNB 203.

In one embodiment, a receiver of the first signal in the disclosure includes the UE 201.

In one embodiment, a transmitter of the first reference signal group in the disclosure includes the gNB 203.

In one embodiment, a receiver of the first reference signal group in the disclosure includes the UE 201.

In one embodiment, a transmitter of the first information block in the disclosure includes the UE 201.

In one embodiment, a receiver of the first information block in the disclosure includes the gNB 203.

### Embodiment 3

Embodiment 3 illustrates a diagram of an embodiment of a radio protocol architecture of a user plane and a control plane according to the disclosure, as shown in FIG. 3.

Embodiment 3 illustrates a diagram of an embodiment of a radio protocol architecture of a user plane and a control plane according to the disclosure, as shown in FIG. 3. FIG. 3 is a diagram illustrating an embodiment of a radio protocol architecture of a user plane 350 and a control plane 300. In FIG. 3, the radio protocol architecture of a control plane 300 between a first communication node equipment (UE, gNB or RSU in V2X) and a second communication node equipment (gNB, UE or RSU in V2X) or between two UEs is illustrated by three layers, which are a Layer 1, a Layer 2 and a Layer 3 respectively. The Layer 1 (L1 layer) is the lowest layer and implements various PHY (physical layer) signal processing functions. The L1 layer will be referred to herein as the PHY 301. The Layer 2 (L2 layer) 305 is above the PHY 301, and is responsible for the links between the first communication node equipment and the second communication node equipment and between two UEs over the PHY 301. The L2 Layer 305 includes a Medium Access Control (MAC) sublayer 302, a Radio Link Control (RLC) sublayer 303, and a Packet Data Convergence Protocol (PDCP) sublayer 304, which are terminated at the second communication node equipment. The PDCP sublayer 304 provides multiplexing between different radio bearers and logical channels. The PDCP sublayer 304 also provides security by encrypting packets and provides support for handover of the first communication node equipment between second communication node equipments. The RLC sublayer 303 provides segmentation and reassembling of higher-layer packets, retransmission of lost packets, and reordering of lost packets to as to compensate for out-of-order reception due to HARQ. The MAC sublayer 302 provides multiplexing between logical channels and transport channels. The MAC sublayer 302 is also responsible for allocating various radio resources (i.e., resource blocks) in one cell among the first communication node equipment. The MAC sublayer 302 is also in charge of HARQ operations.

The RRC sublayer 306 in the Layer 3 (L3 layer) in the control plane 300 is responsible for acquiring radio resources (i.e. radio bearers) and configuring lower layers using an RRC signaling between the second communication node equipment and the first communication node equipment. The radio protocol architecture of the user plane 350 includes a Layer 1 (L1 layer) and a Layer 2 (L2 layer); the radio protocol architecture for the first communication node equipment and the second communication node equipment in the user plane 350 on the PHY 351, the PDCP sublayer 354 in the L2 Layer 355, the RLC sublayer 353 in the L2 Layer 355 and the MAC sublayer 352 in the L2 Layer 355 is substantially the same as the radio protocol architecture on corresponding layers and sublayers in the control plane 300, with the exception that the PDCP sublayer 354 also provides header compression for higher-layer packets so as to reduce radio transmission overheads. The L2 Layer 355 in the user plane 350 further includes a Service Data Adaptation Protocol (SDAP) sublayer 356; the SDAP sublayer 356 is in charge of mappings between QoS flows and Data Radio Bearers (DRBs), so as to support diversification of services. Although not shown, the first communication node equipment may include several higher layers above the L2 Layer 355, including a network layer (i.e. IP layer) terminated at the P-GW on the network side and an application layer terminated at the other end (i.e. a peer UE, a server, etc.) of the connection.

In one embodiment, the radio protocol architecture shown in FIG. 3 is applicable to the first node in the disclosure.

In one embodiment, the radio protocol architecture shown in FIG. 3 is applicable to the second node in the disclosure.

In one embodiment, the first signaling is generated on the PHY 301 or the PHY 351.

In one embodiment, the first signaling is generated on the MAC sublayer 302 or the MAC sublayer 352.

In one embodiment, the first signaling is generated on the RRC sublayer 306.

In one embodiment, the second signaling is generated on the PHY 301 or the PHY 351.

In one embodiment, the second signaling is generated on the MAC sublayer 302 or the MAC sublayer 352.

In one embodiment, the second signaling is generated on the RRC sublayer 306.

In one embodiment, the K signals are generated on the PHY 301 or the PHY 351.

In one embodiment, the third signal is generated on the PHY 301 or the PHY 351.

In one embodiment, the third signal subset is generated on the PHY 301 or the PHY 351.

In one embodiment, the first signal is generated on the PHY 301 or the PHY 351.

In one embodiment, the first reference signal group is generated on the PHY 301 or the PHY 351.

In one embodiment, the first information block is generated on the PHY 301 or the PHY 351.

In one embodiment, the second information block is generated on the RRC sublayer 306.

### Embodiment 4

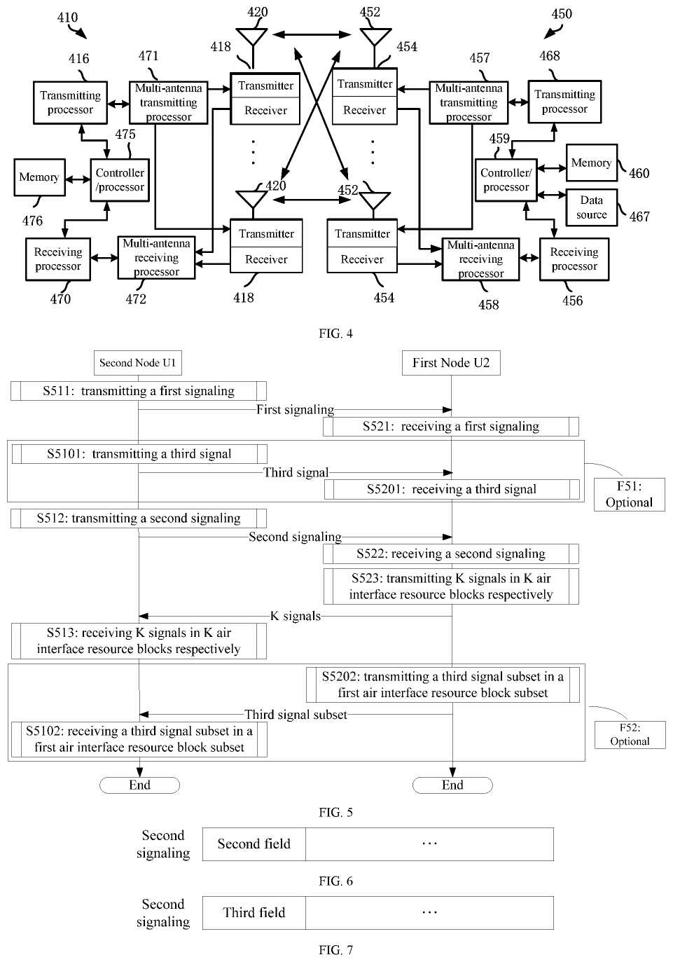

Embodiment 4 illustrates a diagram of a first communication equipment and a second communication equipment according to the disclosure, as shown in FIG. 4. FIG. 4 is a block diagram of a second communication equipment 450 and a first communication equipment 410 that are in communication with each other in an access network.

The first communication equipment 410 includes a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication equipment 450 includes a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication equipment 410 to the second communication equipment 450, at the first communication equipment 410, a higher-layer packet from a core network is provided to the controller/processor 475. The controller/processor 475 provides functions of Layer 2. In DL, the controller/processor 475 provides header compression, encryption, packet segmentation and reordering, multiplexing between a logical channel and a transport channel, and a radio resource allocation for the second communication equipment 450 based on various priority metrics. The controller/processor 475 is also in charge of HARQ operations, retransmission of lost packets, and signalings to the second communication equipment 450. The transmitting processor 416 and the multi-antenna transmitting processor 471 perform various signal processing functions used for Layer 1 (that is, PHY). The transmitting processor 416 performs encoding and interleaving so as to ensure FEC (Forward Error Correction) at the second communication equipment 450 and mappings to constellation clusters corresponding to different modulation schemes (i.e., BPSK, QPSK, M-PSK M-QAM, etc.). The multi-antenna transmitting processor 471 processes the encoded and modulated symbols with digital spatial precoding (including precoding based on codebook and precoding based on non-codebook) and beamforming to generate one or more spatial streams. The transmitting processor 416 subsequently maps each spatial stream into a subcarrier to be multiplexed with a reference signal (i.e., pilot) in time domain and/or frequency domain, and then processes it with Inverse Fast Fourier Transform (IFFT) to generate a physical channel carrying time-domain multicarrier symbol streams. Then, the multi-antenna transmitting processor 471 processes the time-domain multicarrier symbol streams with transmitting analog precoding/beamforming. Each transmitter 418 converts a baseband multicarrier symbol stream provided by the multi-antenna transmitting processor 471 into a radio frequency stream and then provides it to different antennas 420.

In a transmission from the first communication equipment 410 to the second communication equipment 450, at the second communication equipment 450, each receiver 454 receives a signal via the corresponding antenna 452. Each receiver 454 recovers the information modulated to the RF carrier and converts the radio frequency stream into a baseband multicarrier symbol stream to provide to the receiving processor 456. The receiving processor 456 and the multi-antenna receiving processor 458 perform various signal processing functions of Layer 1. The multi-antenna receiving processor 458 processes the baseband multicarrier symbol stream coming from the receiver 454 with receiving analog precoding/beamforming. The receiving processor 458 converts the baseband multicarrier symbol stream subjected to the receiving analog precoding/beamforming operation from time domain into frequency domain using FFT (Fast Fourier Transform). In frequency domain, a physical layer data signal and a reference signal are demultiplexed by the receiving processor 456, wherein the reference signal is used for channel estimation, and the data signal is subjected to multi-antenna detection in the multi-antenna receiving processor 458 to recover any spatial stream targeting the UE 450. Symbols on each spatial stream are demodulated and recovered in the receiving processor 456 to generate a soft decision. Then, the receiving processor 456 decodes and de-interleaves the soft decision to recover the higher-layer data and control signal on the physical channel transmitted by the first communication equipment 410. Next, the higher-layer data and control signal are provided to the controller/processor 459. The controller/processor 459 performs functions of Layer 2. The controller/processor 459 may be connected to the memory 460 that stores program codes and data. The memory 460 may be called a computer readable media. In DL, the controller/processor 459 provides multiplexing between the transport channel and the logical channel, packet reassembling, decryption, header decompression, and control signal processing so as to recover the higher-layer packet coming from the core network. The higher-layer packet is then provided to all protocol layers above Layer 2, or various control signals can be provided to Layer 3 for processing. The controller/processor 459 is also responsible for performing an error detection using the ACK and/or NACK protocol(s) to support HARQ operations.

In a transmission from the second communication equipment 450 to the first communication equipment 410, at the second communication equipment 450, the data source 467 provides a higher-layer packet to the controller/processor 459. The data source 467 illustrates all protocol layers above the L2 layer. Similar as the transmitting function of the first communication equipment 410 described in DL, the controller/processor 459 provides header compression, encryption, packet segmentation and reordering, and multiplexing between a logical channel and a transport channel based on radio resource allocation of the first communication equipment 410 so as to provide the functions of L2 layer used for the control plane and user plane. The controller/processor 459 is also in charge of HARQ operations, retransmission of lost packets, and signalings to the first communication equipment 410. The transmitting processor 468 conducts modulation mapping and channel encoding processing; the multi-antenna transmitting processor 457 performs digital multi-antenna spatial precoding (including precoding based on codebook and precoding based on non-codebook) and beaming processing; and subsequently, the transmitting processor 468 modulates the generated spatial streams into a multicarrier/single-carrier symbol stream, which is subjected to an analog precoding/beamforming operation in the multi-antenna transmitting processor 457 and then is provided to different antennas 452 via the transmitter 454. Each transmitter 452 first converts the baseband symbol stream provided by the multi-antenna transmitting processor 457 into a radio frequency symbol stream and then provides the radio frequency symbol stream to the antenna 452.

In a transmission from the second communication equipment 450 to the first communication equipment 410, the function of the first communication equipment 410 is similar as the receiving function of the second communication equipment 450 described in the transmission from first communication equipment 410 to the second communication equipment 450. Each receiver 418 receives a radio frequency signal via the corresponding antenna 420, converts the received radio frequency signal into a baseband signal, and provides the baseband signal to the multi-antenna receiving processor 472 and the receiving processor 470. The receiving processor 470 and the multi-antenna receiving processor 472 together provide functions of Layer 1. The controller/processor 475 provides functions of Layer 2. The controller/processor 475 may be connected to the memory 476 that stores program codes and data. The memory 476 may be called a computer readable media. The controller/processor 475 provides de-multiplexing between the transport channel and the logical channel, packet reassembling, decryption, header decompression, and control signal processing so as to recover higher-layer packets coming from the UE 450. The higher-layer packet, coming from the controller/processor 475, may be provided to the core network. The controller/processor 475 is also responsible for performing an error detection using the ACK and/or NACK protocol(s) to support HARQ operations.

In one embodiment, the second communication equipment 450 includes at least one processor and at least one memory. The at least one memory includes computer program codes. The at least one memory and the computer program codes are configured to be used in collaboration with the at least one processor. The second communication equipment 450 at least receives a first signaling, receives a second signaling, transmits K signals in K air interface resource blocks respectively, wherein the first signaling is used for determining a first air interface resource block and a first bit block, and the second signaling is used for determining K air interface resource blocks, and the K being a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the second communication equipment 450 includes a memory that stores a computer readable instruction program. The computer readable instruction program generates an action when executed by at least one processor. The action includes receiving a first signaling, receiving a second signaling, transmitting K signals in K air interface resource blocks respectively, wherein the first signaling is used for determining a first air interface resource block and a first bit block, and the second signaling is used for determining K air interface resource blocks, and the K being a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the first communication equipment 410 includes at least one processor and at least one memory. The at least one memory includes computer program codes. The at least one memory and the computer program codes are configured to be used in collaboration with the at least one processor. The first communication equipment 410 at least transmits a first signaling, transmits a second signaling, and receives K signals in K air interface resource blocks respectively, wherein the first signaling is used for determining a first air interface resource block and a first bit block, and the second signaling is used for determining K air interface resource blocks, and the K being a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the first communication equipment 410 includes a memory that stores a computer readable instruction program. The computer readable instruction program generates an action when executed by at least one processor. The action includes: transmitting a first signaling, transmitting a second signaling, and receiving K signals in K air interface resource blocks respectively, wherein the first signaling is used for determining a first air interface resource block and a first bit block, and the second signaling is used for determining K air interface resource blocks, and the K being a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the first node in the disclosure includes the second communication equipment 450.

In one embodiment, the second node in the disclosure includes the first communication equipment 410.

In one embodiment, at least one of the antenna 452, the receiver 454, the receiving processor 456, the multiantenna receiving processor 458, the controller/processor 459, the memory 460 or the data source 467 is used for receiving the first signaling; and at least one of the antenna 420, the transmitter 418, the transmitting processor 416, the multiantenna transmitting processor 471, the controller/processor 475 or the memory 476 is used for transmitting the first signaling.

In one embodiment, at least one of the antenna 452, the receiver 454, the receiving processor 456, the multiantenna receiving processor 458, the controller/processor 459, the memory 460 or the data source 467 is used for receiving the second signaling; and at least one of the antenna 420, the transmitter 418, the transmitting processor 416, the multiantenna transmitting processor 471, the controller/processor 475 or the memory 476 is used for transmitting the second signaling.

In one embodiment, at least one of the transmitter 420, the receiver 418, the receiving processor 470, the multiantenna receiving processor 472, the controller/processor 475 or the memory 476 is used for receiving the K signals in the K air interface resource blocks respectively; and at least one of the antenna 452, the transmitter 454, the transmitting processor 468, the multiantenna transmitting processor 457, the controller/processor 459, the memory 460 or the data source 467 is used for transmitting the K signals in the K air interface resource blocks respectively.

In one embodiment, at least one of the antenna 452, the receiver 454, the receiving processor 456, the multiantenna receiving processor 458, the controller/processor 459, the memory 460 or the data source 467 is used for receiving the third signal; and at least one of the antenna 420, the transmitter 418, the transmitting processor 416, the multiantenna transmitting processor 471, the controller/processor 475 or the memory 476 is used for transmitting the third signal.

In one embodiment, at least one of the antenna 420, the receiver 418, the receiving processor 470, the multiantenna receiving processor 472, the controller/processor 475 or the memory 476 is used for receiving the third signal subset in the first air interface resource block subset; and at least one of the antenna 452, the transmitter 454, the transmitting processor 468, the multiantenna transmitting processor 457, the controller/processor 459, the memory 460 or the data source 467 is used for transmitting the third signal subset in the first air interface resource block subset.

In one embodiment, the second communication equipment 450 includes at least one processor and at least one memory. The at least one memory includes computer program codes. The at least one memory and the computer program codes are configured to be used in collaboration with the at least one processor. The second communication equipment 450 at least receives the first signal, receives the first reference signal group in the first reference signal resource group, and transmits the first information block; wherein a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the second communication equipment 450 includes a memory that stores a computer readable instruction program. The computer readable instruction program generates an action when executed by at least one processor. The action includes: receiving the first signal, receiving the first reference signal group in the first reference signal resource group, and transmitting the first information block; wherein a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the first communication equipment 410 includes at least one processor and at least one memory. The at least one memory includes computer program codes. The at least one memory and the computer program codes are configured to be used in collaboration with the at least one processor. The first communication equipment 410 at least transmits the first signal, transmits the first reference signal group in the first reference signal resource group, and receives the first information block; wherein a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the transmitter of the first information block with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the first communication equipment 410 includes a memory that stores a computer readable instruction program. The computer readable instruction program generates an action when executed by at least one processor. The action includes: transmitting the first signal, transmitting the first reference signal group in the first reference signal resource group, and receiving the first information block; wherein a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the transmitter of the first information block with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, at least one of the antenna 452, the receiver 454, the receiving processor 456, the multiantenna receiving processor 458, the controller/processor 459, the memory 460 or the data source 467 is used for receiving the first signal; and at least one of the antenna 420, the transmitter 418, the transmitting processor 416, the multiantenna transmitting processor 471, the controller/processor 475 or the memory 476 is used for transmitting the first signal.

In one embodiment, at least one of the antenna 452, the receiver 454, the receiving processor 456, the multiantenna receiving processor 458, the controller/processor 459, the memory 460 or the data source 467 is used for receiving the first reference signal group in the first reference signal resource group; and at least one of the antenna 420, the transmitter 418, the transmitting processor 416, the multiantenna transmitting processor 471, the controller/processor 475 or the memory 476 is used for transmitting the first reference signal group in the first reference signal resource group.

In one embodiment, at least one of the antenna 420, the receiver 418, the receiving processor 470, the multiantenna receiving processor 472, the controller/processor 475 or the memory 476 is used for receiving the first information block; and at least one of the antenna 452, the transmitter 454, the transmitting processor 468, the multiantenna transmitting processor 457, the controller/processor 459, the memory 460 or the data source 467 is used for transmitting the first information block.

In one embodiment, at least one of the antenna 452, the receiver 454, the receiving processor 456, the multiantenna receiving processor 458, the controller/processor 459, the memory 460 or the data source 467 is used for receiving the second information block; and at least one of the antenna 420, the transmitter 418, the transmitting processor 416, the multiantenna transmitting processor 471, the controller/processor 475 or the memory 476 is used for transmitting the second information block.

### Embodiment 5

Embodiment 5 illustrates a flowchart of wireless transmission according to one embodiment of the disclosure, as shown in FIG. 5. In FIG. 5, a second node U1 and a first node U2 are communication nodes that perform transmission via an air interface. In FIG. 5, steps in box F51 and F52 are optional respectively.

The second node U1 transmits a first signaling in S511, transmits a third signal in S5101, transmits a second signaling in S512, receives K signals in K air interface resource blocks respectively in S513, and receives a third signal subset in a first air interface resource block subset in S5102.

The first node U2 receives a first signaling in S521, receives a third signal in S5201, receives a second signaling in S522, transmits K signals in K air interface resource blocks respectively in S523, and transmits a third signal subset in a first air interface resource block subset in S5202.

In Embodiment 5, the first signaling is used by the first node U2 to determine a first air interface resource block and a first bit block, the second signaling is used by the first node U2 to determine K air interface resource blocks, and the K is a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the first node U2 is the first node in the disclosure.

In one embodiment, the second node U1 is the second node in the disclosure.

In one embodiment, an air interface between the second node U1 and the first node U2 includes a wireless interface between a base station and a UE.

In one embodiment, an air interface between the second node U1 and the first node U2 includes a wireless interface between a UE and a UE.

In one embodiment, the first signaling is transmitted on a downlink physical layer control channel (that is, a downlink channel capable of carrying physical layer signaling only).

In one embodiment, the first signaling is transmitted on a Physical Downlink Control Channel (PDCCH).

In one embodiment, the first signaling is transmitted on a Physical Sidelink Control Channel (PSCCH).

In one embodiment, the first signaling is transmitted on a downlink physical layer data channel (that is, a downlink channel capable of carrying physical layer data).

In one embodiment, the first signaling is transmitted on a Physical Downlink Shared Channel (PDSCH).

In one embodiment, the first signaling is transmitted on a Physical Sidelink Shared Channel (PSSCH).

In one embodiment, the second signaling is transmitted on a downlink physical layer control channel (that is, a downlink channel capable of carrying physical layer signaling only).

In one embodiment, the second signaling is transmitted on a PDCCH.

In one embodiment, the second signaling is transmitted on a PSCCH.

In one embodiment, the second signaling is transmitted on a downlink physical layer data channel (that is, a downlink channel capable of carrying physical layer data).

In one embodiment, the second signaling is transmitted on a PDSCH.

In one embodiment, the second signaling is transmitted on PSSCH.

In one embodiment, any one of the K signals is transmitted on an uplink physical layer data channel (that is, an uplink channel capable of carrying physical layer data).

In one embodiment, any one of the K signals is transmitted on a Physical Uplink Shared Channel (PUSCH).

In one embodiment, the K signals are transmitted on K different PUSCHs respectively.

In one embodiment, a transport channel corresponding to any one of the K signals is an Uplink Shared Channel (UL-SCH).

In one embodiment, any one of the K signals is transmitted on a PSSCH.

In one embodiment, steps in box F51 in FIG. 5 exist; the first signaling is used by the first node U2 to determine configuration information of the third signal, and the third signal is used by the first node U2 to determine the first bit block.

In one embodiment, the third signal is transmitted on a downlink physical data channel (that is, a downlink channel capable of carrying physical layer data).

In one embodiment, the third signal is transmitted on a PDSCH.

In one embodiment, steps in box F52 in FIG. 5 exist; any one signal in the third signal subset carries the second bit block, the second signaling is used by the first node U2 to determine K0 air interface resource blocks, the K0 air interface resource blocks include the K air interface resource blocks and the first air interface resource block subset, and the K0 is a positive integer greater than 3; and the first air interface resource block subset is orthogonal to the first air interface resource block in time domain.

In one embodiment, any one signal in the third signal subset is transmitted on an uplink physical layer data channel (that is, an uplink channel capable of carrying physical layer data).

In one embodiment, any one signal in the third signal subset is transmitted on a PUSCH.

In one embodiment, a transport channel corresponding to any one signal in the third signal subset is a UL-SCH.

In one embodiment, any one signal in the third signal subset is transmitted on a PSSCH.

### Embodiment 6

Embodiment 6 illustrates a diagram of a scenario in which a second signaling is used for determining K air interface resource blocks according to one embodiment of the disclosure, as shown in FIG. 6. In Embodiment 6, the second signaling includes a second field, and the second field in the second signaling indicates time domain resources occupied by the K air interface resource blocks.

In one embodiment, the second field includes a positive integer number (greater than 1) of bits.

In one embodiment, the second field includes one or more fields in one DCI.

In one embodiment, the second field includes one or more fields in one IE.

In one embodiment, the second field in the second signaling indicates a start time of the K air interface resource blocks.

In one embodiment, the second field in the second signaling indicates a length of time domain resources occupied by each of the K air interface resource blocks.

In one embodiment, the second field in the second signaling indicates a first Start and Length Indicator Value (SLIV), and the first SLIV indicates a start time of the K air interface resource blocks and a length of time domain resources occupied by each of the K air interface resource blocks.

In one embodiment, a start time of the K air interface resource blocks is a start time of a first multicarrier symbol in a first time unit, the second field in the second signaling indicates a time interval between the first time unit and a time unit to which the second signaling belongs and indicates an index of the first multicarrier symbol in the first time unit.

In one embodiment, the second field in the second signaling indicates the K.

In one embodiment, the second signaling includes a fourth field, and the fourth field in the second signaling indicates frequency domain resources occupied by each of the K air interface resource blocks.

In one embodiment, the four field includes a positive integer number (greater than 1) of bits.

In one embodiment, the four field includes one or more fields in one DCI.

In one embodiment, the four field includes one or more fields in one IE.

In one embodiment, the four field in the second signaling indicates a start point and a length of frequency domain resources occupied by each of the K air interface resource blocks.

In one embodiment, one time unit is one slot.

In one embodiment, one time unit is one sub-slot.

In one embodiment, one time unit is one multicarrier symbol.

In one embodiment, one time unit is composed of a positive integer number (greater than 1) of consecutive multicarrier symbols.

### Embodiment 7

Embodiment 7 illustrates a diagram of a scenario in which a second signaling is used for determining K air interface resource blocks according to one embodiment of the disclosure, as shown in FIG. 7. In Embodiment 7, the second signaling includes a third field, the third field in the second signaling indicates a first time window set, the first time window set includes a positive integer number of time windows, the first time window set is used for determining K time windows, and time domain resources occupied by the K air interface resource blocks are the K time windows respectively.

In one embodiment, the third field includes a positive integer number (greater than 1) of bits.

In one embodiment, the third field includes one or more fields in one DCI.

In one embodiment, the third field includes one or more fields in one IE.

In one embodiment, the first time window set includes only 1 time window.

In one embodiment, the first time window set includes multiple time windows.

In one embodiment, any one time window in the first time window set is a continuous period of time.

In one embodiment, any one time window in the first time window set includes a positive integer number of consecutive multicarrier symbols.

In one embodiment, a number of multicarrier symbols included in any time window in the first time window set is equal to the target integer.

In one embodiment, the first time window set includes multiple time windows, and any two of the multiple time windows are equal in length.

In one embodiment, the first time window set includes multiple time windows, and the multiple time windows are pairwise orthogonal.

In one embodiment, the third field in the second signaling indicates a start time of an earliest time window in the first time window set.

In one embodiment, the third field in the second signaling indicates a length of each time window in the first time window set.

In one embodiment, the third field in the second signaling indicates a second SLIV, and the second SLIV indicates a start time of an earliest time window in the first time window set and a length of each time window in the first time window set.

In one embodiment, a start time of an earliest time window in the first time window set is a start time of a second multicarrier symbol in a second time unit, and the third field in the second signal indicates a time interval between the second time unit and a time unit to which the second signaling belongs and indicates an index of the second multicarrier in the second time unit.

In one embodiment, the third field in the second signaling indicates a number of time windows included in the first time window set.

In one embodiment, any one time window in the first time window set is used for determining one or more of the K time windows.

In one embodiment, any one time window in the first time window set is a continuous period of time.

In one embodiment, any one time window in the first time window set includes a positive integer number of consecutive multicarrier symbols.

In one embodiment, for any one given time window in the first time window set, a first reference time window is composed of all multicarrier symbols in the given time window that do not belong to a first multicarrier symbols set; if a number of multicarrier symbols included in the first reference time window that can be used for PUSCH repetition type B transmission is greater than 1, the first reference time window is used for determining a first time window subset in the K time windows; any one time window in the first time window subset is composed of one or more consecutive multicarrier symbols located in one same time unit in the first reference time window that can be used for PUSCH repetition type B transmission; any one time window in the first time window subset is one of the K time windows.

In one embodiment, the first time window subset includes only 1 time window.

In one embodiment, the first time window subset includes multiple time windows.

In one embodiment, the first multicarrier symbol set includes one or more multicarrier symbols.

In one embodiment, the first multicarrier symbol set is configured through an RRC signaling.

### Embodiment 8

Embodiment 8 illustrates a diagram of K air interface resource blocks according to one embodiment of the disclosure, as shown in FIG. 8. In FIG. 8, the K air interface resource blocks are indexed with #0, . . . , #(K−1) respectively.

In one embodiment, any one of the K air interface resource blocks includes time domain resources and frequency domain resources.

In one embodiment, any one of the K air interface resource blocks includes time-frequency resources and code domain resources.

In one embodiment, any one of the K air interface resource blocks occupies a positive integer number (greater than 1) of resource elements in time-frequency domain.

In one embodiment, any one of the K air interface resource blocks occupies a positive integer number of PRBs in frequency domain.

In one embodiment, any one of the K air interface resource blocks occupies a positive integer number of consecutive multicarrier symbols in time domain.

In one embodiment, the K air interface resource blocks are reserved for the second bit block.

In one embodiment, the K air interface resource blocks are reserved for transmission of the second bit block.

In one embodiment, the K air interface resource blocks are reserved for transmissions of K signals respectively.

In one embodiment, the K air interface resource blocks are pairwise orthogonal in time domain.

In one embodiment, any two of the K air interface resource blocks occupy a same number of multicarrier symbols.

In one embodiment, two of the K air interface resource blocks occupy different numbers of multicarrier symbols.

In one embodiment, a number of multicarrier symbols included in any one of the K air interface resource blocks is greater than 1.

In one embodiment, a number of multicarrier symbols included in one of the K air interface resource blocks is equal to 1.

In one embodiment, any two of the K air interface resource blocks occupy a same size of frequency domain resources.

In one embodiment, any two of the K air interface resource blocks occupy same frequency domain resources.

In one embodiment, two of the K air interface resource blocks occupy different frequency domain resources.

In one embodiment, one of the K air interface resource blocks occupies time domain resources which belong to time domain resources occupied by the first air interface resource block.

In one embodiment, one of the K air interface resource blocks occupies time domain resources which are partially overlapping with time domain resources occupied by the first air interface resource block.

### Embodiment 9

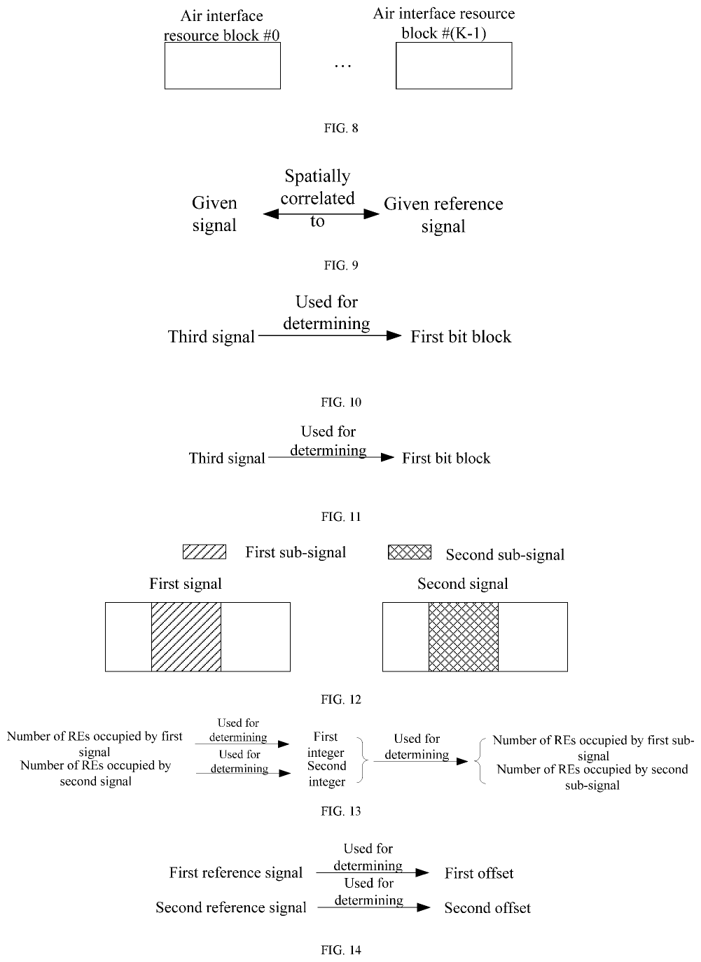

Embodiment 9 illustrates a diagram of a scenario in which a given signal is spatially correlated to a given reference signal according to one embodiment of the disclosure, as shown in FIG. 9. In Embodiment 9, the given signal is any one signal in the first signal subset, and the given reference signal is the first reference signal; or, the given signal is any one signal in the second signal subset, and the given reference signal is the second reference signal.

In one embodiment, the given signal is any one signal in the first signal subset, and the given reference signal is the first reference signal.

In one embodiment, the given signal is any one signal in the second signal subset, and the given reference signal is the second reference signal.

In one embodiment, any one signal in the first signal subset is spatially correlated to the first reference signal.

In one embodiment, any one signal in the second signal subset is spatially correlated to the second reference signal.

In one embodiment, the spatial correlation includes QCL.

In one embodiment, the spatial correlation includes QCL and corresponds to a QCL-TypeA.

In one embodiment, the spatial correlation includes QCL and corresponds to a QCL-TypeB.

In one embodiment, the spatial correlation includes QCL and corresponds to a QCL-TypeC.

In one embodiment, the spatial correlation includes QCL and corresponds to a QCL-TypeD.

In one embodiment, the phrase that a given signal is spatially correlated to a given reference signal includes: a DMRS of the given signal is QCLed with the given reference signal.

In one embodiment, the phrase that a given signal is spatially correlated to a given reference signal includes: a DMRS of the given signal is QCLed with the given reference signal and corresponds to a QCL-TypeD.

In one embodiment, the phrase that a given signal is spatially correlated to a given reference signal includes: a DMRS of the given signal is QCLed with the given reference signal and corresponds to a QCL-TypeA.

In one embodiment, the phrase that a given signal is spatially correlated to a given reference signal includes: the given reference signal is used for determining large-scale properties of a channel experienced by the given signal.

In one embodiment, the phrase that a given signal is spatially correlated to a given reference signal includes: large-scale properties of a channel experienced by the given reference signal can deduce large-scale properties of a channel experienced by the given signal.

In one embodiment, the large-scale properties include one or more of a delay spread, a Doppler spread, a Doppler shift, an average delay or a spatial Rx parameter.

In one embodiment, the phrase that a given signal is spatially correlated to a given reference signal includes: the given reference signal is used for determining a spatial domain filter of the given signal.

In one embodiment, the phrase that a given signal is spatially correlated to a given reference signal includes: the first node receives the given reference signal and transmits the given signal using a same spatial domain filter.

In one embodiment, the phrase that a given signal is spatially correlated to a given reference signal includes: the first node transmits the given reference signal and the given signal using a same spatial domain filter.

In one embodiment, the phrase that a given signal is spatially correlated to a given reference signal includes: a precoding of the given reference signal is used for determining a precoding of the given signal.

In one embodiment, the phrase that a given signal is spatially correlated to a given reference signal includes: the given signal and the given reference signal employ a same precoding.

In one embodiment, the phrase that a given signal is spatially correlated to a given reference signal includes: a transmitting antenna port of the given reference signal is used for determining a transmitting antenna port of the given signal.

In one embodiment, the phrase that a given signal is spatially correlated to a given reference signal includes: the given signal and the given reference signal are transmitted by a same antenna port.

### Embodiment 10

Embodiment 10 illustrates a diagram of a scenario in which a third signal is used for determining a first bit block according to one embodiment of the disclosure, as shown in FIG. 10. In Embodiment 10, the third signal carries a third bit block, the third bit block is one TB, or one CBG, or one CB; and the first bit block indicates whether the third bit block is correctly received.

In one embodiment, the third signal carries a baseband signal.

In one embodiment, the third signal carries a radio signal.

In one embodiment, the third signal carries a radio frequency signal.

In one embodiment, the configuration information of the third signal includes one or more of time domain resources, frequency domain resources, an MCS, a DMRS port, a HARQ process number, an RV or an NDI.

In one embodiment, the first signaling indicates explicitly the configuration information of the third signal.

In one embodiment, the first signaling indicates implicitly the configuration information of the third signal.

In one embodiment, the first signaling includes one bit string, and the bit string indicates the configuration information of the third signal.

In one subembodiment, the bit string includes one or more fields in one DCI.

In one subembodiment, the bit string includes one or more fields in one IE.

In one embodiment, the phase that the first signaling is used for determining the first bit block includes: the first bit block indicates whether the third bit block is correctly received.

In one embodiment, the phase that the first signaling is used for determining the first bit block includes: the first bit block indicates whether the third signal is correctly received.

### Embodiment 11

Embodiment 11 illustrates a diagram of a scenario in which a third signal is used for determining a first bit block according to one embodiment of the disclosure, as shown in FIG. 11. In Embodiment 11, the third signal includes a reference signal, and a measurement for the third signal is used for determining the first bit block.

In one embodiment, the third signal includes a CSI-RS.

In one embodiment, the third signal includes an SSB.

In one embodiment, the configuration information of the third signal includes one or more of time domain resources, frequency domain resources, code domain resources, a number of RS (Reference Signal) ports, an RS sequence, a cyclic shift, a density, a power control offset, a scrambling code, a TCI state, QCL information or a number of repetitions.

In one embodiment, the third signal includes a reference signal, the first signaling indicates an identifier of the third signal, and the identifier of the third signal is used for determining the configuration information of the third signal.

In one embodiment, the third signal includes a reference signal, and the identifier of the third signal includes a CSI-RS Resource Indicator (CRI).

In one embodiment, the third signal includes a reference signal, and the identifier of the third signal includes an SSB Resource Indicator (SSBRI).

In one embodiment, the third signal includes a reference signal, the first signaling indicates a first report configuration, and the first report configuration indicates the third signal.

In one embodiment, the first signaling is used for triggering the first report configuration.

In one embodiment, the first signaling indicates a non-periodic triggering state corresponding to the first report configuration.

In one embodiment, the first report configuration includes one CSI report.

In one embodiment, the first report configuration includes part or all fields in one IE.

In one embodiment, the first report configuration includes part or all fields in a CSI-ReportConfig IE.

In one embodiment, the third signal includes a reference signal correlated to the first report configuration and used for channel measurement.

In one embodiment, the third signal includes a reference signal correlated to the first report configuration and used for interference measurement.

In one embodiment, the first report configuration indicates an identifier of the third signal, and the identifier of the third signal is used for determining the configuration information of the third signal.

In one embodiment, a measurement for the third signal is used for determining one Signal-to-Interference and Noise Ratio (SINR), the SINR is used for determining one Channel Quality Indicator (CQI) through looking up a table, and the first bit block carries the CQI.

In one embodiment, a measurement for the third signal is used for determining one CSI, and the first bit block carries the CSI.

In one embodiment, a measurement for the third signal is used for determining a first channel matrix, and the first channel matrix is used for determining one CSI, and the first bit block carries the CSI.

In one embodiment, a Reference Signal Received Power (RSRP) of the third signal is used for determining the first bit block.

In one embodiment, a channel measurement for the third signal is used for determining the first bit block.

In one embodiment, an interference measurement for the third signal is used for determining the first bit block.

In one embodiment, the phrase that the first signaling is used for determining the first bit block includes: a measurement for the third signal is used for determining the first bit block.

### Embodiment 12

Embodiment 12 illustrates a diagram of a first signal, a first sub-signal, a second signal and a second sub-signal according to one embodiment of the disclosure, as shown in FIG. 12. In Embodiment 12, the first signal includes the first sub-signal, and the first sub-signal carries the first bit block; the second signal includes the second sub-signal, and the second sub-signal carries the first bit block.

In one embodiment, the first sub-signal is uncorrelated to the second bit block.

In one embodiment, the first sub-signal does not carry the second bit block.

In one embodiment, the first signal includes a third sub-signal, and the third sub-signal carries the second bit block.

In one embodiment, the first signal is composed of the first sub-signal and the third sub-signal.

In one embodiment, the third sub-signal is uncorrelated to the first bit block.

In one embodiment, the third sub-signal does not carry the first bit block.

In one embodiment, the third sub-signal and the first sub-signal are generated by outputs of different channel codings respectively.

In one embodiment, the second sub-signal is uncorrelated to the second bit block.

In one embodiment, the second sub-signal does not carry the second bit block.

In one embodiment, the second signal includes a fourth sub-signal, and the fourth sub-signal carries the second bit block.

In one embodiment, the second signal is composed of the second sub-signal and the fourth sub-signal.

In one embodiment, the fourth sub-signal is uncorrelated to the first bit block.

In one embodiment, the fourth sub-signal does not carry the first bit block.

In one embodiment, the fourth sub-signal and the second sub-signal are generated by outputs of different channel codings respectively.

In one embodiment, the first sub-signal and the second sub-signal are generated by an output of a same channel coding.

In one embodiment, the first sub-signal and the second sub-signal are repeated transmissions of an output of a same channel coding.

In one embodiment, the first sub-signal and the second sub-signal are generated by outputs of different channel codings.

In one embodiment, the third sub-signal and the fourth sub-signal are generated by an output of a same channel coding.

In one embodiment, the third sub-signal and the fourth sub-signal correspond to different RVs of an output of one same channel coding.

### Embodiment 13

Embodiment 13 illustrates a diagram of a number of resource elements occupied by a first sub-signal and a number of resource elements occupied by a second sub-signal according to one embodiment of the disclosure, as shown in FIG. 13. In Embodiment 13, a number of resource elements occupied by the first signal and a number of resource elements occupied by the second signal are used for determining a first integer and a second integer respectively; the first integer and the second integer are used for determining a number of resource elements occupied by the first sub-signal and a number of resource elements occupied by the second sub-signal.

In one embodiment, the resource element refers to an RE.

In one embodiment, one resource element occupies one multicarrier symbol in time domain and occupies one subcarrier in frequency domain.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA).

In one embodiment, the multicarrier symbol is a Discrete Fourier Transform Spread OFDM (DFT-S-OFDM).

In one embodiment, the first integer and the second integer are positive integers respectively.

In one embodiment, the first integer and the second integer are positive integers greater than 1 respectively.

In one embodiment, the first integer is a number of resource elements occupied by the first signal.

In one embodiment, the second integer is a number of resource elements occupied by the second signal.

In one embodiment, the first integer is a number of resource elements occupied by the first signal in a first symbol set; the first symbol set is composed of all multicarrier symbols starting from a first symbol that do not carry a DMRS in a first PUSCH, the first symbol is a first multicarrier symbol not carrying a DMRS in the first PUSCH behind a last multicarrier symbol occupied by a first DMRS, and the first PUSCH is a PUSCH carrying the first signal.

In one embodiment, the second integer is a number of resource elements occupied by the second signal in a second symbol set; the second symbol set is composed of all multicarrier symbols starting from a second symbol that do not carry a DMRS in a second PUSCH, the second symbol is a first multicarrier symbol not carrying a DMRS in the second PUSCH behind a last multicarrier symbol occupied by a first DMRS, and the second PUSCH is a PUSCH carrying the second signal.

In one embodiment, a number of resource elements occupied by the first sub-signal is not greater than a product of the first integer and a third offset, and the third offset is a non-negative real number not greater than 1.

In one embodiment, a number of resource elements occupied by the second sub-signal is not greater than a product of the second integer and a fourth offset, and the fourth offset is a non-negative real number not greater than 1.

In one embodiment, a minimum one of the first integer and the second integer is used for determining a number of resource elements occupied by the first sub-signal and a number of resource elements occupied by the second sub-signal.

In one embodiment, a number of resource elements occupied by the first sub-signal is not greater than a product of a third offset and a minimum one of the first integer and the second integer, and the third offset is a non-negative real number not greater than 1.

In one embodiment, a number of resource elements occupied by the second sub-signal is not greater than a product of a third offset and a minimum one of the first integer and the second integer, and the third offset is a non-negative real number not greater than 1.

In one embodiment, a number of resource elements occupied by the second sub-signal is not greater than a product of a fourth offset and a minimum one of the first integer and the second integer, and the fourth offset is a non-negative real number not greater than 1.

In one embodiment, the third offset is configured through an RRC signaling.

In one embodiment, the third offset belongs to a third offset set, and the second signaling indicates the third offset from the third offset set.

In one embodiment, the fourth offset is configured through an RRC signaling.

In one embodiment, the fourth offset belongs to a fourth offset set, and the second signaling indicates the fourth offset from the fourth offset set.

In one embodiment, the third offset is not equal to the fourth offset.

In one embodiment, a minimum one of a number of resource elements occupied by the first signal and a number of resource elements occupied by the second signal is used for determining a number of resource elements occupied by the first sub-signal and a number of resource elements occupied by the second sub-signal.

In one embodiment, a number of resource elements occupied by the first sub-signal is not greater than a minimum one of a number of resource elements occupied by the first signal and a number of resource elements occupied by the second signal.

In one embodiment, a number of resource elements occupied by the second sub-signal is not greater than a minimum one of a number of resource elements occupied by the first signal and a number of resource elements occupied by the second signal.

### Embodiment 14

Embodiment 14 illustrates a diagram of a scenario in which a first reference signal is used for determining a first offset and a second reference signal is used for determining a second offset according to one embodiment of the disclosure, as shown in FIG. 14.

In one embodiment, the first reference signal is used by the first node to determine the first offset, and the second reference signal is used by the first node to determine the second offset.

In one embodiment, the first offset is one non-negative real number.

In one embodiment, the second offset is one non-negative real number.

In one embodiment, the first offset is one non-negative real number not less than 1.

In one embodiment, the second offset is one non-negative real number not less than 1.

In one embodiment, the first offset is not equal to the second offset.

In one embodiment, a correspondence between the first reference signal and the first offset is configured through an RRC signaling; and a correspondence between the second reference signal and the second offset is configured through an RRC signaling.

In one embodiment, the second signaling indicates a first reference signal set, the first reference signal set includes the first reference signal and the second reference signal; an index of the first reference signal in the first reference signal set is used for determining the first offset, and an index of the second reference signal in the first reference signal set is used for determining the second offset.

In one embodiment, a first offset set includes the first offset and the second offset, an index of the first reference signal in the first reference signal set is used for determining the first offset from the first offset set, and an index of the second reference signal in the first reference signal set is used for determining the second offset from the first offset set.

In one embodiment, a first offset subset includes the first offset, and a second offset subset includes the second offset; the first offset subset corresponds to a first index set, and the second offset subset corresponds to a second index set; the first reference signal is used for determining a first index, and the first index belongs to the first index set; the second reference signal is used for determining a second index, and the second index belongs to the second index set.

In one subembodiment, the first index and the second index are non-negative integers respectively.

In one subembodiment, the first offset subset and the second offset subset are configured through an RRC signaling.

In one subembodiment, the first index set and the second index set are configured through an RRC signaling.

In one subembodiment, a correspondence between the first offset subset and the first index set is configured through an RRC signaling; and a correspondence between the second offset subset and the second index set is configured through an RRC signaling.

In one subembodiment, the first offset subset includes the first offset only.

In one subembodiment, the second offset subset includes the second offset only.

In one subembodiment, the first offset subset includes multiple offsets, and the second signaling indicates the first offset from the first offset subset.

In one subembodiment, the first offset subset includes multiple offsets, and a number of bits included in the first bit block is used for determining the first offset from the first offset subset.

In one subembodiment, the first offset subset includes multiple offsets, and a type of information carried by the first bit block is used for determining the first offset from the first offset subset.

In one subembodiment, the second offset subset includes multiple offsets, and the second signaling indicates the second offset from the second offset subset.

In one subembodiment, the second offset subset includes multiple offsets, and a number of bits included in the first bit block is used for determining the second offset from the second offset subset.

In one subembodiment, the second offset subset includes multiple offsets, and a type of information carried by the first bit block is used for determining the second offset from the second offset subset.

In one subembodiment, the first index is an index of the first reference signal in the first reference signal set.

In one subembodiment, the first index is an identifier of the first reference signal.

In one subembodiment, the first index is an identifier of a reference signal resource set to which the first reference signal belongs.

In one subembodiment, the first index is an index of a CORESET pool to which a first COntrol REsource SET (CORESET) belongs, and the first CORESET is a CORESET to which a scheduling signaling for an MAC CE signaling triggering the first reference signal belongs.

In one subembodiment, the second index is an index of the second reference signal in the first reference signal set.

In one subembodiment, the second index is an identifier of the second reference signal.

In one subembodiment, the second index is an identifier of a reference signal resource set to which the second reference signal belongs.

In one subembodiment, the second index is an index of a CORESET pool to which a second COntrol REsource SET (CORESET) belongs, and the second CORESET is a CORESET to which a scheduling signaling for an MAC CE signaling triggering the second reference signal belongs.

In one embodiment, a type of information carried by the first bit block includes one or more of a HARQ-ACK, a CSI part 1 or a CSI part 2.

In one embodiment, the first offset is used by the first node to determine a number of resource elements occupied by the first sub-signal, and the second offset is used by the first node to determine a number of resource elements occupied by the second sub-signal.

### Embodiment 15

Embodiment 15 illustrates a diagram of a number of resource elements occupied by a first sub-signal according to one embodiment of the disclosure, as shown in FIG. 15. In Embodiment 15, the number of resource elements occupied by a first sub-signal is a minimum one of a first reference integer and a first limit integer, the first reference integer is equal to (a fifth offset multiplied by a third integer multiplied by a number of bits included in the first bit block) divided by a number of bit included in the second bit block; the third integer is equal to a number of resource elements occupied by the first signal in a third symbol set, the third symbol set is composed of all multicarrier symbols in a first PUSCH that do not carry a DMRS, and the first PUSCH is a PUSCH carrying the first signal.

In one embodiment, the fifth offset is one non-negative real number.

In one embodiment, the fifth offset is configured through an RRC signaling.

In one embodiment, the second signaling indicates the fifth offset.

In one embodiment, the fifth offset is the first offset.

In one embodiment, the first limit integer is equal to a product of the first integer and the third offset.

In one embodiment, the first limit integer is equal to a product of the third offset and a minimum one of the first integer and the second integer.

In one embodiment, the first signal includes a first sub-signal, and the first sub-signal carries the first bit block; the second signal includes a second sub-signal, and the second sub-signal carries the first bit block; and a number of resource elements occupied by the first sub-signal is not equal to a number of resource elements occupied by the second sub-signal.

In one embodiment, a number of multicarrier symbols occupied by the first signal is used for determining a number of resource elements occupied by the first sub-signal.

### Embodiment 16

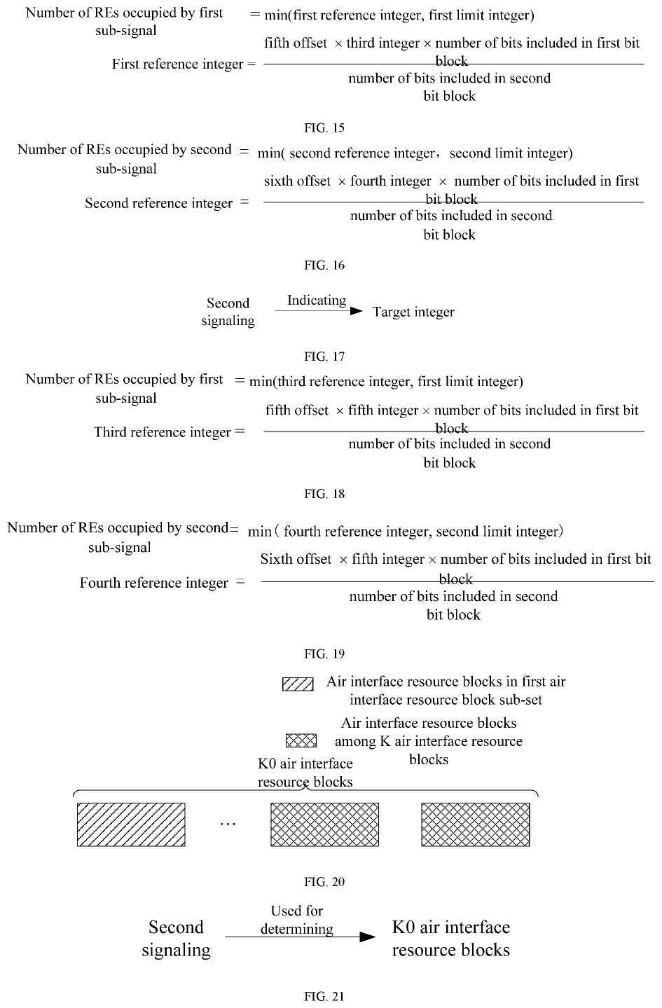

Embodiment 16 illustrates a diagram of a number of resource elements occupied by a second sub-signal according to one embodiment of the disclosure, as shown in FIG. 16. In Embodiment 16, the number of resource elements occupied by a second sub-signal is a minimum one of a second reference integer and a second limit integer, the second reference integer is equal to (a sixth offset multiplied by a fourth integer multiplied by a number of bits included in the first bit block) divided by a number of bit included in the second bit block; the fourth integer is equal to a number of resource elements occupied by the second signal in a fourth symbol set, the fourth symbol set is composed of all multicarrier symbols in a second PUSCH that do not carry a DMRS, and the second PUSCH is a PUSCH carrying the second signal.

In one embodiment, the sixth offset is one non-negative real number.

In one embodiment, the sixth offset is configured through an RRC signaling.

In one embodiment, the second signaling indicates the sixth offset.

In one embodiment, the sixth offset is the second offset.

In one embodiment, the second limit integer is equal to a product of the second integer and the fourth offset.

In one embodiment, the second limit integer is equal to a product of the third offset and a minimum one of the first integer and the second integer.

In one embodiment, the second limit integer is equal to a product of the fourth offset and a minimum one of the first integer and the second integer.

In one embodiment, the sixth offset is the fifth offset.

In one embodiment, the sixth offset is not equal to the fifth offset.

### Embodiment 17

Embodiment 17 illustrates a diagram of a scenario in which a second signaling indicates a target integer according to one embodiment of the disclosure, as shown in FIG. 17.

In one embodiment, the target integer is a positive integer.

In one embodiment, the target integer is a positive integer greater than 1.

In one embodiment, a unit of the target integer is a multicarrier symbol.

In one embodiment, the target integer is a number of multicarrier symbols occupied by one nominal repeated transmission.

In one embodiment, the target integer is a number of multicarrier symbols occupied by one nominal repeated transmission of the first bit block.

In one embodiment, the target integer is a number of multicarrier symbols occupied by one nominal repeated transmission of the first bit block scheduled by the second signaling.

In one embodiment, a number of multicarrier symbols occupied by any one of the K air interface resource blocks is equal to the target integer.

In one embodiment, a number of multicarrier symbols occupied by any one of the K air interface resource blocks is less than the target integer.

In one embodiment, the second signaling indicates explicitly the target integer.

In one embodiment, the second signaling indicates implicitly the target integer.

In one embodiment, the second signaling includes a second field, and the second field in the second signaling indicates the target integer.

In one embodiment, the second field in the second signaling indicates a first SLIV, and the first SLIV indicates the target integer.

### Embodiment 18

Embodiment 18 illustrates a diagram of a scenario in which a target integer is used for determining a number of resource elements occupied by a first sub-signal according to one embodiment of the disclosure, as shown in FIG. 18. In Embodiment 18, the target integer is used for determining a fifth integer, a number of resource elements occupied by the first sub-signal is a minimum one of a third reference integer and a first limit integer, the third reference integer is equal to (a fifth offset multiplied by a fifth integer multiplied by a number of bits included in the first bit block) divided by a number of bits included in the second bit block.

In one embodiment, the target integer is used by the first node to determine a number of resource elements occupied by the first sub-signal.

In one embodiment, the fifth integer is one positive integer.

In one embodiment, the target integer and a number of subcarriers assigned to any one of the K signals are used together to determine the fifth integer.

In one embodiment, in one nominal repeated transmission of the first bit block, a number of multicarrier symbols assigned to a DMRS is used for determining the fifth integer.

In one embodiment, in one nominal repeated transmission of the first bit block, a number of resource elements assigned to a PTRS is used for determining the fifth integer.

In one embodiment, the target integer is equal to P, the P is a positive integer greater than 1, and one nominal repeated transmission of the first bit block occupies P multicarrier symbols; a first symbol subset is composed one or more of the P multicarrier symbols, and any one multicarrier symbol in the first symbol subset does not carry a DMRS; the fifth integer is equal to a summation of all integers in a first integer set; a number of integers included in the first integer set is equal to a number of symbols included in the first symbol subset; all integers included in the first integer set are one-to-one corresponding to all symbols included in the first symbol subset; a given integer is any one integer in the first integer set, and the given integer corresponds to a given symbol in the first symbol subset; the given integer is equal to W minus a number of subcarriers among W subcarriers that are assigned to a PTRS in a given symbol; the W is a number of subcarriers assigned to any one of the K signals, and the W is a positive integer greater than 1; and the W subcarriers are frequency domain resources assigned to any one of the K signals.

In one embodiment, the first limit integer is equal to a minimum one of the first integer and the second integer.

In one embodiment, the first limit integer is equal to a product of a third offset and a minimum one of the first integer and the second integer.

In one embodiment, the fifth offset is the first offset.

In one embodiment, the fifth offset belongs to a second offset set, and the second offset set includes multiple offsets; and the second singling indicates the fifth offset from the second offset set.

In one subembodiment, the second offset set is configured through an RRC signaling.

In one embodiment, a number of resource elements occupied by the first sub-signal is uncorrelated to a number of multicarrier symbols occupied by the first signal.

### Embodiment 19

Embodiment 19 illustrates a diagram of a scenario in which a target integer is used for determining a number of resource elements occupied by a second sub-signal according to one embodiment of the disclosure, as shown in FIG. 19. In Embodiment 19, the target integer is used for determining a fifth integer, a number of resource elements occupied by the second sub-signal is a minimum one of a fourth reference integer and a second limit integer, the fourth reference integer is equal to (a sixth offset multiplied by a fifth integer multiplied by a number of bits included in the first bit block) divided by a number of bits included in the second bit block.

In one embodiment, the target integer is used by the first node to determine a number of resource elements occupied by the second sub-signal.

In one embodiment, the second limit integer is equal to a minimum one of the first integer and the second integer.

In one embodiment, the second limit integer is equal to a product of a third offset and a minimum one of the first integer and the second integer.

In one embodiment, the sixth offset is the fifth offset.

In one embodiment, the sixth offset belongs to a fifth offset set, and the fifth offset set includes multiple offsets; and the second singling indicates the sixth offset from the fifth offset set.

In one subembodiment, the fifth offset set is configured through an RRC signaling.

In one embodiment, a number of resource elements occupied by the second sub-signal is uncorrelated to a number of multicarrier symbols occupied by the second signal.

### Embodiment 20

Embodiment 20 illustrates a diagram of a first air interface resource block subset, K air interface resource blocks and K0 air interface resource blocks according to one embodiment of the disclosure, as shown in FIG. 20. In Embodiment 20, the K0 air interface resource blocks include the K air interface resource blocks and the first air interface resource block subset.

In one embodiment, the first air interface resource block subset includes one or more air interface resource blocks.

In one embodiment, the first air interface resource block subset includes one air interface resource block only.

In one embodiment, the first air interface resource block subset includes multiple air interface resource blocks.

In one embodiment, the third signal subset includes one or more signals.

In one embodiment, the third signal subset includes one signal only.

In one embodiment, the third signal subset includes multiple signals.

In one embodiment, a number of air interface resource blocks included in the first air interface resource block subset is equal to a number of signals included in the third signal subset.

In one embodiment, the first air interface resource block subset includes one air interface resource block only, the third signal subset includes one signal only, and the one signal is transmitted in the one air interface resource block.

In one embodiment, the first air interface resource block subset includes K1 air interface resource blocks, the third signal subset includes K1 signals, the K1 is a positive integer greater than 1, and the K1 signals are transmitted in the K1 air interface resource blocks respectively.

In one embodiment, any one signal in the third signal subset is uncorrelated to the first bit block.

In one embodiment, any one signal in the third signal subset does not carry the first bit block.

In one embodiment, any one air interface resource block in the first air interface resource block subset includes time domain resources and frequency domain resources.

In one embodiment, any one air interface resource block in the first air interface resource block subset includes time-frequency resources and code domain resources.

In one embodiment, any one air interface resource block in the first air interface resource block subset occupies a positive integer number (greater than 1) of resource elements in time-frequency domain.

In one embodiment, any one air interface resource block in the first air interface resource block subset occupies a positive integer number of PRBs.

In one embodiment, any one air interface resource block in the first air interface resource block subset occupies a positive integer number of consecutive multicarrier symbols in time domain.

In one embodiment, the first air interface resource block subset is reserved for the second bit block.

In one embodiment, the first air interface resource block subset is reserved for transmission of the third signal subset.

In one embodiment, any one air interface resource block in the first air interface resource block subset is orthogonal to the first air interface resource block in time domain.

In one embodiment, one air interface resource block in the first air interface resource block subset has a start time not earlier than an end time of one latest air interface resource block among the K air interface resource blocks.

In one embodiment, one air interface resource block in the first air interface resource block subset has an end time not later than a start time of one earliest air interface resource block among the K air interface resource blocks.

In one embodiment, the K0 is equal to a summation of the K and a number of air interface resource blocks included in the first air interface resource block subset.

In one embodiment, the K0 is greater than a summation of the K and a number of air interface resource blocks included in the first air interface resource block subset.

In one embodiment, the K0 air interface resource blocks are pairwise orthogonal in time domain.

In one embodiment, any two of the K0 air interface resource blocks occupy a same number of multicarrier symbols.

In one embodiment, two of the K0 air interface resource blocks occupy different numbers of multicarrier symbols.

In one embodiment, any two of the K0 air interface resource blocks occupy a same frequency domain resource.

In one embodiment, two of the K0 air interface resource blocks occupy different frequency domain resources.

In one embodiment, the K air interface resource blocks have consecutive positions in the K0 air interface resource blocks in time domain.

In one embodiment, the K air interface resource blocks are composed of all air interface resource blocks among the K0 air interface resource blocks that are overlapping with the first air interface resource block in time domain.

In one embodiment, the K air interface resource blocks are composed of all air interface resource blocks among the K0 air interface resource blocks that are overlapping with the first air interface resource block in time domain and include more than 1 multicarrier symbol.

In one embodiment, the K0 signals include the third signal subset and the K signals, and the K0 signals are K0 repeated transmissions of the second bit block respectively.

In one subembodiment, the K0 signals are K0 repeated transmissions of the second bit block in time domain respectively.

In one embodiment, the second signaling indicates scheduling information of each signal among the K0 signals.

In one embodiment, the second signaling indicates explicitly scheduling information of one signal among the K0 signals.

In one embodiment, the second signaling indicates implicitly scheduling information of one signal among the K0 signals.

In one embodiment, the K0 signals include a given signal, the second signaling indicates explicitly part scheduling information of the given signal and indicates implicitly the other part scheduling information of the given signal.

In one embodiment, the second signaling indicates explicitly all scheduling information of a first signal among the K0 signals and part or all scheduling information of any one of the K0 signals other than the first signal.

In one embodiment, the K0 signals correspond to a same MCS.

In one embodiment, the K0 signals correspond to a same HARQ process number.

In one embodiment, the K0 signals correspond to a same NDI.

In one embodiment, two of the K0 signals correspond to a same RV.

In one embodiment, two of the K0 signals correspond to different RVs.

### Embodiment 21

Embodiment 21 illustrates a diagram of a scenario in which a second signaling is used for determining K0 air interface resource blocks according to one embodiment of the disclosure, as shown in FIG. 21.

In one embodiment, the second signaling indicates the K0 air interface resource blocks.

In one embodiment, the second signaling indicates explicitly the K0.

In one embodiment, the K0 is configured through a higher layer parameter.

In one embodiment, the second signaling indicates explicitly time domain resources occupied by the K0 air interface resource blocks.

In one embodiment, the second signaling includes a second field, and the second field in the second signaling indicates time domain resources occupied by the K0 air interface resource blocks.

In one embodiment, the second field in the second signaling indicates a start time of the K0 air interface resource blocks.

In one embodiment, the second field in the second signaling indicates a length of time domain resources occupied by each of the K0 air interface resource blocks.

In one embodiment, the second field in the second signaling indicates a first SLIV, and the first SLIV indicates a start time of the K0 air interface resource blocks and a length of time domain resources occupied by each of the K0 air interface resource blocks.

In one embodiment, a start time of the K0 air interface resource blocks is a start time of a third multicarrier symbol in a third time unit, the second field in the second signaling indicates a time interval between the third time unit and a time unit to which the second signaling belongs and indicates an index of the third multicarrier symbol in the third time unit.

In one embodiment, the second field in the second signaling indicates the K0.

In one embodiment, the second signaling indicates implicitly time domain resources occupied by the K0 air interface resource blocks.

In one embodiment, the second signaling includes a third field, the third field in the second signaling indicates a first time window set, the first time window set is used for determining K0 time windows, and time domain resources occupied by the K0 air interface resource blocks are the K0 time windows respectively.

In one embodiment, any one of the K0 time windows is a continuous period of time.

In one embodiment, any one of the K0 time windows includes a positive integer number of consecutive multicarrier symbols.

In one embodiment, any one time window in the first time window set is used for determining one or more of the K0 time windows.

In one embodiment, for any one given time window in the first time window set, a first reference time window is composed of all multicarrier symbols in the given time window that do not belong to a first multicarrier symbols set; if a number of multicarrier symbols included in the first reference time window that can be used for PUSCH repetition type B transmission is greater than 1, the first reference time window is used for determining a first time window subset in the K0 time windows; any one time window in the first time window subset is composed of one or more consecutive multicarrier symbols located in one same time unit in the first reference time window that can be used for PUSCH repetition type B transmission; any one time window in the first time window subset is one of the K0 time windows.

In one embodiment, the second signaling indicates explicitly frequency domain resources occupied by the K0 air interface resource blocks.

In one embodiment, the second signaling includes a fourth field, and the fourth field in the second signaling indicates frequency domain resources occupied by each of the K0 air interface resource blocks.

### Embodiment 22

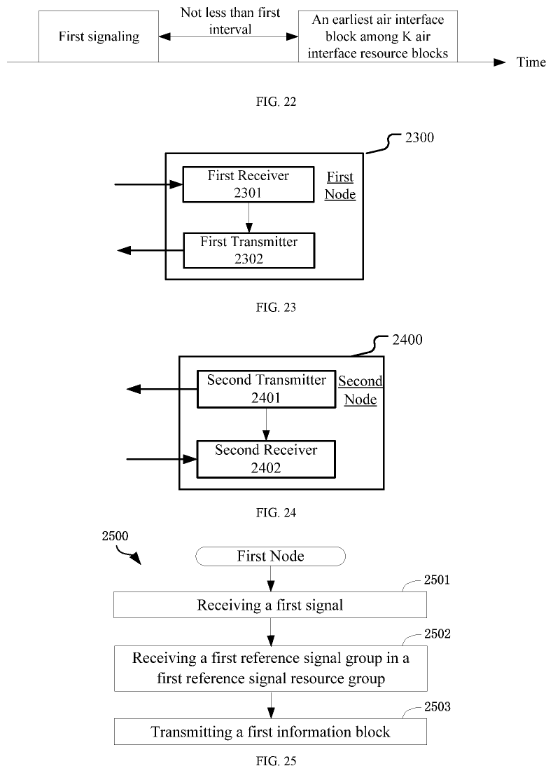

Embodiment 22 illustrates a diagram of a time interval between an earliest air interface resource block among K air interface resource blocks and a first signaling, as shown in FIG. 22. In Embodiment 22, the time interval between the earliest air interface resource block among K air interface resource blocks and the first signaling is not less than the first interval.

In one embodiment, a start time of time domain resources occupied by an earliest air interface resource block among the K air interface resource blocks is later than an end time of time domain resources occupied by the first signaling.

In one embodiment, the time interval between the earliest air interface resource block among K air interface resource blocks and the first signaling refers to: a time interval between a start time of time domain resources occupied by the earliest air interface resource block and an end time of time domain resources occupied by the first signaling.

In one embodiment, the time interval between the earliest air interface resource block among K air interface resource blocks and the first signaling refers to: a time interval between a start time of time domain resources occupied by the earliest air interface resource block and a start time of time domain resources occupied by the first signaling.

In one embodiment, the time interval between the earliest air interface resource block among K air interface resource blocks and the first signaling refers to: a time interval between a start time of a time unit to which the earliest air interface resource block and a start time of a time unit to which the first signaling belongs.

In one embodiment, a time interval between time domain resources occupied by the earliest air interface resource block among the K air interface resource blocks and time domain resources occupied by the third signal is not less than a first interval.

In one embodiment, a time interval between time domain resources occupied by the earliest air interface resource block among the K air interface resource blocks and time domain resources occupied by the second signaling is not less than a first interval.

In one embodiment, the first interval is one non-negative real number.

In one embodiment, the first interval is one non-negative integer.

In one embodiment, the first interval is in unit of second.

In one embodiment, the first interval is in unit of millisecond.

In one embodiment, a unit of the first interval is a multicarrier symbol.

In one embodiment, the first interval is correlated to a processing capability of the first node.

In one embodiment, the first interval is correlated to a subcarrier spacing corresponding to the third signal.

In one embodiment, the first interval is correlated to a subcarrier spacing corresponding to the first signaling.

In one embodiment, the first interval is correlated to a subcarrier spacing corresponding to the K signals.

In one embodiment, the first interval is correlated to a subcarrier spacing corresponding to the first air interface resource block.

In one embodiment, the first interval is preconfigured.

In one embodiment, the first interval is calculated by a predefined method according to a first subcarrier spacing, the first subcarrier spacing is correlated to one or more of a subcarrier spacing corresponding to the third signal, a subcarrier spacing corresponding to the first signaling, a subcarrier spacing corresponding to the K signals or a subcarrier corresponding to the first air interface resource block.

### Embodiment 23

Embodiment 23 illustrates a structure block diagram of a processing device in a first node according to one embodiment of the disclosure, as shown in FIG. 23. In FIG. 23, the processing device 2300 in the first node includes a first receiver 2301 and a first transmitter 2302.

In Embodiment 23, the first receiver 2301 receives a first signaling and a second signaling, and the first transmitter 2302 transmits K signals in K air interface resource blocks respectively.

In Embodiment 23, the first signaling is used for determining a first air interface resource block and a first bit block, the second signaling is used for determining K air interface resource blocks, and the K is a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the first receiver 2301 receives a third signal, the first signaling is used for determining configuration information of the third signal, and the third signal is used for determining the first bit block.

In one embodiment, the first signal includes a first sub-signal, and the first sub-signal carries the first bit block; the second signal includes a second sub-signal, and the second sub-signal carries the first bit block; and a number of resource elements occupied by the first sub-signal is equal to a number of resource elements occupied by the second sub-signal.

In one embodiment, the first signal includes a first sub-signal, and the first sub-signal carries the first bit block; the second signal includes a second sub-signal, and the second sub-signal carries the first bit block; the first reference signal is used for determining a first offset, and the second reference signal is used for determining a second offset; and the first offset and the second offset are used for determining a number of resource elements occupied by the first sub-signal and a number of resource elements occupied by the second sub-signal respectively.

In one embodiment, the first signal includes a first sub-signal, and the first sub-signal carries the first bit block; the second signal includes a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

In one embodiment, the first transmitter 2302 transmits a third signal subset in a first air interface resource block subset; any one signal in the third signal subset carries the second bit block, the second signaling is used for determining K0 air interface resource blocks, the K0 air interface resource blocks include the K air interface resource blocks and the first air interface resource block subset, and the K0 is a positive integer greater than 3; and the first air interface resource block subset is orthogonal to the first air interface resource block in time domain.

In one embodiment, a time interval between an earliest air interface resource block among the K air interface resource blocks and the first signaling is not less than a first interval.

In one embodiment, the first node is a UE.

In one embodiment, the first node is a relay node.

In one embodiment, the first receiver 2301 includes at least one of the antenna 452, the receiver 454, the receiving processor 456, the multiantenna receiving processor 458, the controller/processor 459, the memory 460 or the data source 467.

In one embodiment, the first transmitter 2303 includes at least one of the antenna 452, the transmitter 454, the transmitting processor 468, the multiantenna transmitting processor 457, the controller/processor 459, the memory 460 or the data source 467.

### Embodiment 24

Embodiment 24 illustrates a structure block diagram of a processing device in a second node according to one embodiment of the disclosure, as shown in FIG. 24. In FIG. 24, the processing device 2400 in the second node includes a second transmitter 2401 and a second receiver 2402.

In Embodiment 24, the second transmitter 2401 transmits a first signaling and a second signaling, and the second receiver 2402 receives K signals in K air interface resource blocks respectively.

In Embodiment 24, the first signaling is used for determining a first air interface resource block and a first bit block, the second signaling is used for determining K air interface resource blocks, and the K is a positive integer greater than 2; the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset include at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

In one embodiment, the second transmitter 2401 transmits a third signal, the first signaling is used for determining configuration information of the third signal, and the third signal is used for determining the first bit block.

In one embodiment, the first signal includes a first sub-signal, and the first sub-signal carries the first bit block; the second signal includes a second sub-signal, and the second sub-signal carries the first bit block; and a number of resource elements occupied by the first sub-signal is equal to a number of resource elements occupied by the second sub-signal.

In one embodiment, the first signal includes a first sub-signal, and the first sub-signal carries the first bit block; the second signal includes a second sub-signal, and the second sub-signal carries the first bit block; the first reference signal is used for determining a first offset, and the second reference signal is used for determining a second offset; and the first offset and the second offset are used for determining a number of resource elements occupied by the first sub-signal and a number of resource elements occupied by the second sub-signal respectively.

In one embodiment, the first signal includes a first sub-signal, and the first sub-signal carries the first bit block; the second signal includes a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

In one embodiment, the second receiver 2402 receives a third signal subset in a first air interface resource block subset; any one signal in the third signal subset carries the second bit block, the second signaling is used for determining K0 air interface resource blocks, the K0 air interface resource blocks include the K air interface resource blocks and the first air interface resource block subset, and the K0 is a positive integer greater than 3; and the first air interface resource block subset is orthogonal to the first air interface resource block in time domain.

In one embodiment, a time interval between an earliest air interface resource block among the K air interface resource blocks and the first signaling is not less than a first interval.

In one embodiment, the second node is a base station.

In one embodiment, the second node is a UE.

In one embodiment, the second node is a relay node.

In one embodiment, the second transmitter 2401 includes at least one of the antenna 420, the transmitter 418, the transmitting processor 416, the multiantenna transmitting processor 471, the controller/processor 475 or the memory 476.

In one embodiment, the second receiver 2402 includes at least one of the antenna 420, the receiver 418, the receiving processor 470, the multiantenna receiving processor 472, the controller/processor 475 or the memory 476.

### Embodiment 25

Embodiment 25 illustrates a flowchart of a first signal, a first reference signal group and a first information block according to one embodiment of the disclosure, as shown in FIG. 25. In 2500 in FIG. 25, each box represents one step. In particular, the order of the steps in the box does not represent a specific precedence relationship in time between the steps.

In Embodiment 25, the first node in the disclosure receives a first signal in S2501, receives a first reference signal group in a first reference signal resource group in S2502, and transmits a first information block in S2503. Herein, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the first signal includes a baseband signal.

In one embodiment, the first signal includes a radio signal.

In one embodiment, the first signal includes a radio frequency signal.

In one embodiment, the first signal carries one Transport Block (TB).

In one embodiment, the first signal carries one Code Block (CB).

In one embodiment, the first signal carries one Code Block Group (CBG).

In one embodiment, the first reference signal resource group includes one or more reference signal resources.

In one embodiment, the first reference signal group includes one or more reference signals.

In one embodiment, the first reference signal resource group includes one reference signal resource only, and the first reference signal group includes one reference signal only; and the one reference signal resource is reserved for the one reference signal.

In one embodiment, the first reference signal resource group includes N reference signal resources, the first reference signal group includes N reference signals, and the N is a positive integer greater than 1; and the N reference signal resources are reserved for the N reference signals respectively.

In one embodiment, a number of reference signal resources included in the first reference signal resource group is equal to a number of reference signals included in the first reference signal group.

In one embodiment, the first reference signal resource group includes a Channel State Information-Reference Signal (CSI-RS) resource.

In one embodiment, the first reference signal resource group includes a CSI-RS resource set.

In one embodiment, the first reference signal resource group includes a Synchronization Signal/physical broadcast channel Block (SSB) resource.

In one embodiment, the first reference signal resource group includes a Sounding Reference Signal (SRS) resource.

In one embodiment, the first reference signal resource group includes an SRS resource set.

In one embodiment, any one reference resource in the first reference signal resource group includes a CSI-RS resource or SSB resource.

In one embodiment, the first reference signal group includes a CSI-RS.

In one embodiment, the first reference signal group includes an SSB.

In one embodiment, the first reference signal group includes an SRS.

In one embodiment, any one reference signal in the first reference signal group includes a CSI-RS or SSB.

In one embodiment, two reference signals in the first reference signal group cannot be assumed to be QCLed.

In one embodiment, two reference signals in the first reference signal group cannot be assumed to be QCLed or correspond to a QCL-TypeD.

In one embodiment, two reference signals in the first reference signal group are QCLed.

In one embodiment, two reference signals in the first reference signal group are QCLed and correspond to a QCL-TypeD.

In one embodiment, one reference signal in the first reference signal group appears many times in time domain.

In one embodiment, one reference signal in the first reference signal group appears periodically in time domain.

In one embodiment, one reference signal in the first reference signal group appears only once in time domain.

In one embodiment, all reference signals in the first reference signal group are sequentially indexed in the first reference signal group.

In one embodiment, one reference signal in the first reference signal group is received by the first node before the first signal.

In one embodiment, one reference signal in the first reference signal group is received by the first node after the first signal.

In one embodiment, one reference signal in the first reference signal group occupies a same time unit as the first signal.

In one embodiment, any one reference signal in the first reference signal group occupies a same time unit as the first signal.

In one embodiment, one reference signal in the first reference signal group occupies a different time unit than the first signal.

In one embodiment, one reference signal in the first reference signal group is received by the first node before the second information block.

In one embodiment, one reference signal in the first reference signal group is received by the first node after the second information block.

In one embodiment, the first information block includes higher layer information.

In one embodiment, the first information block includes Radio Resource Control (RRC) layer information.

In one embodiment, the first information block includes Medium Access Control layer Control Element (MAC CE) information.

In one embodiment, the first information block includes physical layer information.

In one embodiment, the first information block includes Uplink control information (UCI).

In one embodiment, the first information block includes a Hybrid Automatic Repeat reQuest-Acknowledgement (HARQ-ACK).

In one embodiment, the first information block includes Channel State Information (CSI).

In one embodiment, the first information block includes a Channel Quality Indicator (CQI).

In one embodiment, the first information block includes a Precoding Matrix Indicator (PMI).

In one embodiment, the first information block does not include a PMI.

In one embodiment, the first information block includes a Rank Indicator (RI).

In one embodiment, the first information block does not include an RI.

In one embodiment, the first information block includes a CSI-RS Resource Indicator (CRI).

In one embodiment, the first information block does not include a CRI.

In one embodiment, the first information block includes an SSB Resource indicator (SSBRI).

In one embodiment, the first information block does not include an SSBRI.

In one embodiment, the first channel quality includes a CQI.

In one embodiment, the first channel quality is one CQI.

In one embodiment, the first channel quality includes a Reference Signal Received Power (RSRP).

In one embodiment, the first channel quality includes a Signal-to-noise and interference ratio (SINR).

In one embodiment, the first channel quality is one CQI, and the first information block includes a CQI index corresponding to the first channel quality.

In one embodiment, the first channel quality is a channel quality of wideband.

In one embodiment, the first channel quality is a channel quality of sub-band.

In one embodiment, the phrase that a measurement for the first reference signal group is used for generating the first information block includes: a measurement for one or more reference signals in the first reference signal group is used for generating the first information block.

In one embodiment, the phrase that a measurement for the first reference signal group is used for generating the first information block includes: a measurement for each reference signal in the first reference signal group is used for generating the first information block.

In one embodiment, the phrase that a measurement for the first reference signal group is used for generating the first information block includes: a measurement for part reference signals in the first reference signal group is used for generating the first information block.

In one embodiment, a measurement for one or more reference signals in the first reference signal group is used for determining one SINR, the SINR is used for determining one CQI through looking up a table, and the first information block carries the CQI.

In one embodiment, a measurement for one or more reference signals in the first reference signal group is used for determining one CSI, and the first information block carries the CSI.

In one embodiment, a measurement for one or more reference signals in the first reference signal group is used for determining a first channel matrix, the first channel matrix is used for determining one CSI, and the first information block carries the CSI.

In one embodiment, an RSRP of one or more reference signals in the first reference signal group is used for determining the first information block.

In one embodiment, a channel measurement for one or more reference signals in the first reference signal group is used for determining the first information block.

In one embodiment, an interference measurement for one or more reference signals in the first reference signal group is used for determining the first information block.

In one embodiment, the first reference signal group is used for a channel measurement.

In one embodiment, the first node obtains a channel measurement used for calculating a CSI included in the first information block only based on the first reference signal group before the first reference resource block.

In one embodiment, the first node obtains a channel measurement used for calculating a CSI included in the first information block only based on a nearest first reference signal group before the first reference resource block.

In one embodiment, the first reference signal group is used for an interference measurement.

In one embodiment, the first node obtains an interference measurement used for calculating a CSI included in the first information block only based on the first reference signal group before the first reference resource block.

In one embodiment, the first node obtains an interference measurement used for calculating a CSI included in the first information block only based on a nearest first reference signal group before the first reference resource block.

In one embodiment, the first bit block includes one TB.

In one embodiment, the first bit block is one TB.

In one embodiment, the first bit block includes one CB.

In one embodiment, the first bit block includes one CBG.

In one embodiment, the first bit block includes a bit obtained after one TB is processed through channel coding and rate matching.

In one embodiment, the first bit block includes a bit obtained after one CB is processed through channel coding and rate matching.

In one embodiment, the first bit block includes a bit obtained after one CBG is processed through channel coding and rate matching.

In one embodiment, the first bit block is transmitted on a Physical Downlink Shared Channel (PDSCH).

In one embodiment, the first bit block is transmitted on a Physical Sidelink Shared Channel (PSSCH).

In one embodiment, the first bit block includes a positive integer number (greater than 1) of bits.

In one embodiment, all bits in the first bit block are sequentially arranged in the first bit block.

In one embodiment, the first bit block includes a Cyclic Redundancy Check (CRC) bit.

In one embodiment, the first bit block does not occupy a multicarrier symbol that carries a DMRS in the first reference resource block.

In one embodiment, the transmission block error rate refers to a Transport Block Error Probability.

In one embodiment, the first threshold is a positive real number less than 1.

In one embodiment, the first threshold is 0.1.

In one embodiment, the first threshold is 0.00001.

In one embodiment, the first threshold is 0.000001.

In one embodiment, the first threshold is a positive real number not greater than 0.1 but not less than 0.000001.

In one embodiment, a probability that the first bit block is erroneously received by the first node is not greater than the first threshold.

In one embodiment, the first node judges according to a CRC that a probability that the first bit block is incorrectly received is not greater than the first threshold.

In one embodiment, the first threshold is configured through an RRC signaling.

In one embodiment, the first report configuration indicates explicitly the first threshold.

In one embodiment, the first report configuration indicates implicitly the first threshold.

In one embodiment, the transmission mode corresponding to the first channel quality includes a modulation scheme, a code rate and a transport block size.

In one embodiment, the transmission mode corresponding to the first channel quality includes a modulation scheme.

In one embodiment, the transmission mode corresponding to the first channel quality includes a code rate.

In one embodiment, the transmission mode corresponding to the first channel quality includes a transport block size.

In one embodiment, the transmission mode corresponding to the first channel quality may be applied to a PDSCH transmitted in the first reference resource block.

In one embodiment, the first channel quality indicates one modulation scheme.

In one embodiment, the first channel quality indicates one code rate.

In one embodiment, a modulation scheme corresponding to the first channel quality is the modulation scheme indicated by the first channel quality.

In one embodiment, a transport block size corresponding to the first channel quality is obtained according to a method in 5.1.3.2 in 3GPP TS (Technical Specification) 38.214.

In one embodiment, a code rate corresponding to the first channel quality is the code rate indicated by the first channel quality.

In one embodiment, a code rate corresponding to the first channel quality is an actual code rate resulted when a modulation scheme-transport block size pair corresponding to the first channel quality is applied to the first reference resource block.

In one embodiment, when a modulation scheme-transport block size pair corresponding to the first channel quality is applied to the first reference resource block, a resulted actual code rate is one available code rate most approximate to a code rate indicated by the first channel quality.

In one embodiment, in the condition that the actual code rates resulted when more than one modulation scheme-transport block size pairs corresponding to the first channel quality are applied to the first reference resource block have a same degree of proximity to a code rate indicated by the first channel quality, among the more than one modulation scheme-transport block size pairs corresponding to the first channel quality, only a modulation scheme-transport block size pair corresponding to a minimum transport block size is used for determining the actual code rate in the first reference resource block.

In one embodiment, the first condition set includes: the first bit block employs a modulation scheme corresponding to the first channel quality.

In one embodiment, the first condition set includes: the first bit block employs a code rate corresponding to the first channel quality.

In one embodiment, the first condition set includes: the first bit block employs a transmission block size corresponding to the first channel quality.

In one embodiment, the first condition set includes: the first bit block employs a modulation scheme, a code rate, and a transmission block size corresponding to the first channel quality.

In one embodiment, the first rank number includes one RI.

In one embodiment, the first rank number is a number of layers.

In one embodiment, the first rank number is a positive integer.

In one embodiment, the first rank number is a positive integer not greater than 8.

In one embodiment, the first rank number is equal to 1.

In one embodiment, the first rank number is greater than 1.

In one embodiment, the number of layers of the first signal refers to a number of layers.

In one embodiment, the number of layers of the first signal is a positive integer.

In one embodiment, the number of layers of the first signal is a positive integer not greater than 8.

In one embodiment, the number of layers of the first signal is fixed to 1.

In one embodiment, the number of layers of the first signal is configured through an RRC signaling.

In one embodiment, the number of layers of the first signal is dynamically configured.

In one embodiment, the rank number is equal to the number of layers of the first signal.

In one embodiment, an absolute value of a difference value between the rank number and the number of layers of the first signal is not greater than a second threshold.

In one embodiment, the first information block includes the first rank number.

In one embodiment, the first information block does not include the first rank number.

In one embodiment, the first rank number does not need to be indicated by the first information block.

In one embodiment, the first condition set includes: the number of layers of the first bit block is equal to the first rank number.

In one embodiment, the phrase that the first channel quality is calculated under the condition of the first rank number includes: the first node calculates the first channel quality under the condition of assuming that the number of layers of the first bit block is equal to the rank number.

In one embodiment, the first information block includes a first CRI, and the first channel quality is obtained under the condition of the first CRI.

In one embodiment, the first CRI indicates a first reference signal, the first reference signal belongs to a first reference signal group, and a DMRS port of a PDSCH carrying the first bit block is QCLed with the first reference signal.

In one subembodiment, a DMRS port of a PDSCH carrying the first bit block is QCLed with the first reference signal and corresponds to a QCL-TypeD.

In one embodiment, the first information block includes M CRIs, and the M is a positive integer greater than 1; and the first channel quality is obtained under the condition of the M CRIs.

In one embodiment, the M CRIs indicate M reference signals respectively, any one of the M reference signals belongs to the first reference signal group, any one DMRS port of a PDSCH carrying the first bit block is QCLed with any one of the M reference signals.

In one subembodiment, any one DMRS port of a PDSCH carrying the first bit block is QCLed with any one of the M reference signals and corresponds to a QCL-TypeD.

In one embodiment, the first information block indicates a first PMI, and the first channel quality is calculated under the condition of the first PMI.

In one embodiment, the first channel quality is one CQI, the first channel quality is one CQI in a first CQI set that corresponds to a maximum CQI index; for any one given CQI in the first CQI set, the given CQI is calculated under the condition of the first rank number; when a first bit block occupies a first reference resource block and a given condition set is met, the first bit block can be received by the first node with a transmission block error rate not exceeding a first threshold; the given condition set includes: the first bit block employs a transmission mode corresponding to the given CQI; the transmission mode corresponding to the given CQI includes one or more of a modulation scheme, a code rate or a transmission block size.

In one subembodiment, the given condition set includes: the first bit block employs a modulation scheme, a code rate and a transport block size corresponding to the given CQI.

In one subembodiment, the given CQI is calculated under the condition of the first PMI.

In one subembodiment, the given CQI is calculated under the condition of the first CRI.

In one subembodiment, the given CQI is calculated under the condition of the M CRIs.

In one subembodiment, the given CQI is calculated under the condition of the first reference signal subgroup.

### Embodiment 26

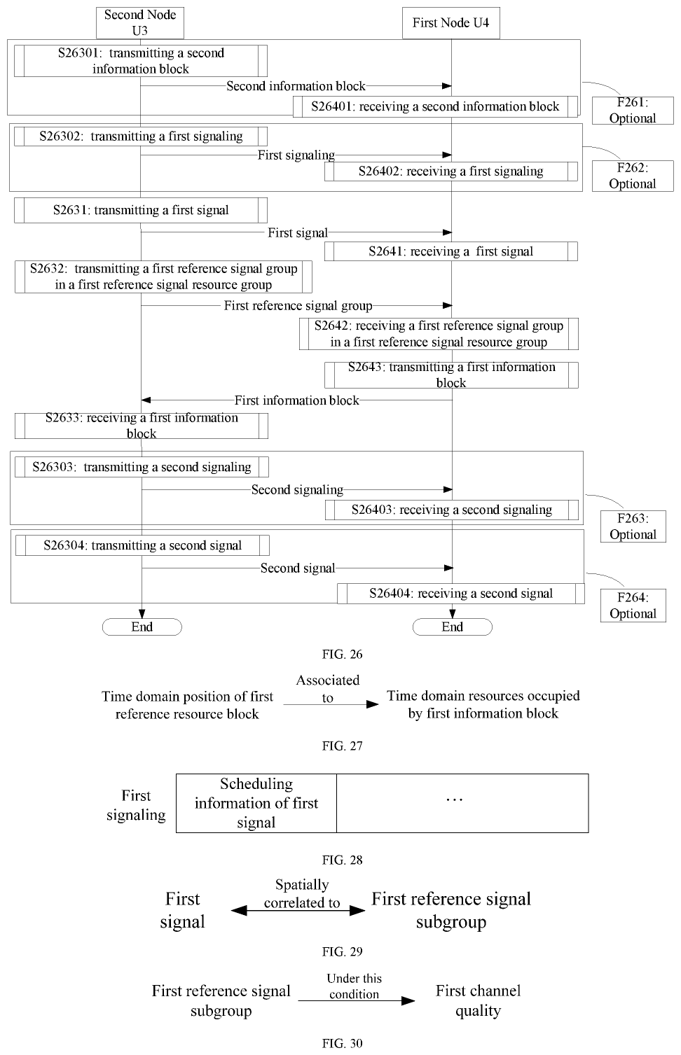

Embodiment 26 illustrates a flowchart of wireless transmission according to one embodiment of the disclosure, as shown in FIG. 26. In FIG. 26, a second node U3 and a first node U4 are communication nodes that perform transmissions via an air interface. In FIG. 26, steps in box F261 to F264 are optional respectively.

The second node U3 transmits a second information block in S26301, transmits a first signaling in S26302, transmits a first signal in S2631, transmits a first reference signal group in a first reference signal resource group in S2632, receives a first information block in S2633, transmits a second signaling in S26303, and transmits a second signal in S26304.

The first node U4 receives a second information block in S26401, receives a first signaling in S26402, receives a first signal in S2641, receives a first reference signal group in a first reference signal resource group in S2642, transmits a first information block in S2643, receives a second signaling in S26403, and receives a second signal in S26404.

In Embodiment 26, a measurement for the first reference signal group is used by the first node U4 to generate the first information block, and the first information block includes a first channel quality; a number of layers of the first signal is used by the first node U4 to determine a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the first node U4 is the first node in the disclosure.

In one embodiment, the second node U3 is the second node in the disclosure.

In one embodiment, an air interface between the second node U3 and the first node U4 includes a radio interface between a base station and a UE.

In one embodiment, an air interface between the second node U3 and the first node U4 includes a radio interface between a UE and a UE.

In one embodiment, the second node U3 is a maintenance base station for a serving cell of the first node U4.

In one embodiment, the first signal is transmitted on a downlink physical layer data channel (that is, a downlink channel capable of carrying physical layer data).

In one embodiment, the first signal is transmitted on a PDSCH.

In one embodiment, the first signal is transmitted on a PSSCH.

In one embodiment, the first information block is transmitted on an uplink physical layer control channel (that is, an uplink channel capable of carrying physical layer signalings only).

In one embodiment, the first information block is transmitted on a PUCCH.

In one embodiment, the first information block is transmitted on an uplink physical layer data channel (that is, an uplink channel capable of carrying physical layer data).

In one embodiment, the first information block is transmitted on a PUSCH.

In one embodiment, the first information block is transmitted on a PSSCH.

In one embodiment, steps in box F261 shown in FIG. 26 exist; the second information block includes a first report configuration, the first report configuration indicates a first report metric set and the first reference signal group, and the first report metric set is used by the first node U4 to determine the content of the first information block.

In one embodiment, the second information block is transmitted on a PDSCH.

In one embodiment, the second information block is transmitted on a PSSCH.

In one embodiment, steps in box F262 shown in FIG. 26 exist; the first signaling includes scheduling information of the first signal, and the first signaling triggers the transmission of the first information block; the first signaling indicates the number of layers of the first signal.

In one embodiment, the first signaling is transmitted on a downlink physical layer control channel (that is, a downlink channel capable of carrying physical layer signaling).

In one embodiment, the first signaling is transmitted on a PDCCH.

In one embodiment, the first signaling is transmitted on a PSCCH.

In one embodiment, steps in both box F263 and box F5264 shown in FIG. 26 exist; the second signaling includes scheduling information of the second signal; and the first channel quality is used for determining an MCS of the second signal.

In one embodiment, the first channel quality is used by the second node to determine an MCS of the second signal.

In one embodiment, the second signaling includes a DCI.

In one embodiment, the second signaling includes one of more fields in one DCI.

In one embodiment, the second signaling includes an RRC signaling.

In one embodiment, the second signaling is transmitted on a PDCCH.

In one embodiment, the second signal includes a radio signal.

In one embodiment, the second signal is transmitted on a PDSCH.

In one embodiment, the second node determines an MCS of the second signal according to an estimated value of a received SINR of the first bit block, an estimated value of a received SINR of the second signal and the first channel quality.

In one embodiment, the second node selects a modulation scheme and a code rate corresponding to the first channel quality as an MCS of the second signal.

In one embodiment, none of the steps in box F263 and box F264 shown in FIG. 26 exist.

### Embodiment 27

Embodiment 27 illustrates a diagram of a scenario in which a time domain position of a first reference resource block is associated to a time domain resource occupied by a first information block according to one embodiment of the disclosure, as shown in FIG. 27.

In one embodiment, the first reference resource block is a CSI reference resource corresponding to a CSI included in the first information block.

In one embodiment, a CSI reference resource corresponding to the first channel quality is the first reference resource block.

In one embodiment, the first reference resource block includes time domain resources and frequency domain resources.

In one embodiment, the first reference resource block includes time-frequency resources and code domain resources.

In one embodiment, the first reference resource block occupies a positive integer number (greater than 1) of Resource Elements (REs) in time-frequency domain.

In one embodiment, one RE occupies one multicarrier symbol in time domain and occupies one subcarrier in frequency domain.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA).

In one embodiment, the multicarrier symbol is a Discrete Fourier Transform Spread OFDM (DFT-S-OFDM).

In one embodiment, the first reference resource block occupies a positive integer number of PRBs in frequency domain.

In one embodiment, the first reference resource block occupies a positive integer number of multicarrier symbols in time domain.

In one embodiment, the first reference resource block occupies 1 slot in time domain.

In one embodiment, the first reference resource block occupies a positive integer number of multicarrier symbols in 1 slot in time domain.

In one embodiment, time domain resources occupied by the first information block are used for determining time domain resources occupied by the first reference resource block.

In one embodiment, a first time unit is a time unit to which the first information block belongs, and the first time unit is used for determining time domain resources occupied by the first reference resource block.

In one embodiment, the first reference resource block is located before the first time unit in time domain.

In one embodiment, the first reference resource block belongs to the first time unit.

In one embodiment, the first reference resource block does not belong to the first time unit.

In one embodiment, the first reference resource block is located behind the first time unit in time domain.

In one embodiment, a target time unit is used for determining time domain resources occupied by the first reference resource block, the target time unit is not later than a reference time unit, and the first time unit is used for determining the reference time unit; a time interval between the target time unit and the reference time unit is a first interval; and the first interval is a non-negative integer.

In one subembodiment, the reference time unit is the first time unit.

In one subembodiment, the first time unit is a time unit n1, the reference time unit is a time unit n, the n is equal to a rounded-down product of n1 and a first specific value, the first specific value is a ratio of 2 to the power of a first parameter to 2 to the power of a second parameter, the first parameter is a subcarrier spacing configuration corresponding to the first reference signal group, and the second parameter is a subcarrier spacing configuration corresponding to the first information block.

In one subembodiment, the unit of the first interval is the time unit.

In one subembodiment, the first interval is a numerical value not less than a third parameter, such that the target time unit is a time unit which can be used by a transmitter of the first reference signal group to transmit a radio signal to the first node; and the third parameter is a non-negative integer.

In one subembodiment, the first interval is a numerical value not less than a third parameter, such that the target time unit is a valid downlink time unit; and the third parameter is a non-negative integer.

In one subembodiment, at least one of a delay requirement and a subcarrier spacing configuration corresponding to the first reference signal group is used for determining the third parameter.

In one subembodiment, the first reference resource block belongs to the target time unit.

In one subembodiment, the M reference resource subblocks all belong to the target time unit.

In one subembodiment, a latest one of the M reference resource subblocks belongs to the target time unit.

In one subembodiment, an earliest one of the M reference resource subblocks belongs to the target time unit.

In one embodiment, the first reference resource block occupies a positive integer number of multicarrier symbols in a time unit to which the first reference resource block belongs.

In one embodiment, the first reference resource block does not occupy two earliest multicarrier symbols in a time unit to which the first reference resource block belongs.

In one embodiment, the M reference resource subblocks belong respectively to M consecutive time units which can be used by a transmitter of the first reference signal group to transmit a radio signal to the first node.

In one embodiment, the M reference resource subblocks belong respectively to M consecutive valid downlink time units.

In one embodiment, one time unit is one slot.

In one embodiment, one time unit is one sub-slot.

In one embodiment, one time unit is one multicarrier symbol.

In one embodiment, one time unit is composed of a positive integer number (greater than 1) of consecutive multicarrier symbols.

In one embodiment, a frequency domain position of the first reference resource block is associated to a frequency domain resource corresponding to a CSI included in the first information block.

In one embodiment, a CSI included in the first information block is obtained against a first sub-band set, and the first sub-band set is used for determining frequency domain resources occupied by the first reference resource block.

In one embodiment, the first channel quality is obtained against a first sub-band set, and the first sub-band set is used for determining frequency domain resources occupied by the first reference resource block.

In one embodiment, the first sub-band set includes one sub-band only.

In one embodiment, the first sub-band set includes a positive integer number (greater than 1) of sub-bands.

In one embodiment, a positive integer number (greater than 1) of sub-bands included in the first sub-band set are consecutive in frequency domain.

In one embodiment, a positive integer number (greater than 1) of sub-bands included in the first sub-band set are inconsecutive in frequency domain.

In one embodiment, any two sub-bands in the first sub-band set include a same number of PRBs.

In one embodiment, any two sub-bands in the first sub-band set are orthogonal in frequency domain.

In one embodiment, the first report configuration indicates the first sub-band set.

In one embodiment, a first field in the first report configuration indicates the first sub-band set.

In one subembodiment, the first field includes part or all information in a csi-ReportingBand field in a CSI-ReportConfig IE.

In one subembodiment, the first field includes part or all information in a reportFreqConfiguration field in a CSI-ReportConfig IE.

In one subembodiment, the first field includes information in one or more fields in one IE.

In one embodiment, the first reference resource block occupies one or more sub-bands in the first sub-band set.

In one embodiment, frequency domain resources occupied by the first reference resource block belong to the first sub-band set.

In one embodiment, frequency domain resources occupied by the first reference resource block are the first sub-band set.

In one embodiment, the first reference resource block occupies part sub-bands in the first sub-band set only.

### Embodiment 28

Embodiment 28 illustrates a diagram of a first signaling according to one embodiment of the disclosure, as shown in FIG. 28. In Embodiment 28, the first signaling includes scheduling information of the first signal, and the first signaling triggers transmission of the first information block; and the first signaling indicates a number of layers of the first signal.

In one embodiment, the first signaling includes a physical layer signaling.

In one embodiment, the first signaling includes a dynamic signaling.

In one embodiment, the first signaling includes a Layer 1 (L1) signaling.

In one embodiment, the first signaling includes a Layer 1 (L1) control signaling.

In one embodiment, the first signaling includes Downlink Control Information (DCI).

In one embodiment, the first signaling includes one or more fields in one DCI.

In one embodiment, the first signaling includes one or more fields in one SCI.

In one embodiment, the first signaling includes a DCI for downlink grant.

In one embodiment, the first signaling includes a DCI for Semi-Persistent Scheduling (SPS) activation.

In one embodiment, the first signaling includes a Radio Resource Control (RRC) signaling.

In one embodiment, the first signaling includes a Medium Access Control layer Control Element (MAC CE) signaling.

In one embodiment, the scheduling information includes one or more of time domain resources, frequency domain resources, a Modulation and Coding Scheme (MCS), a DeModulation Reference Signals (DMRS) port, a Hybrid Automatic Repeat reQuest (HARQ) process number, a Redundancy Version (RV) or a New Data Indicator (NDI).

In one embodiment, the first signaling triggers one time of reporting for the first report configuration.

In one embodiment, the first signaling includes a first field, and the first field in the first signaling triggers transmission of the first information block.

In one embodiment, the first field in the first signaling indicates the first report configuration.

In one embodiment, the first field includes information in a CSI request field.

In one embodiment, a name of the first field includes a CSI.

In one embodiment, the first field includes a positive integer number of bits.

In one embodiment, the first report configuration is one of P candidate report configurations, and the P is a positive integer greater than 1; the first field in the first signaling indicates the first report configuration from the P candidate report configurations.

In one embodiment, the first report configuration is one of P candidate report configurations, and the P is a positive integer greater than 1; the first field in the first signaling indicates an index of the first report configuration in the P candidate report configurations.

In one embodiment, the first signaling indicates explicitly a number of layers of the first signal.

In one embodiment, the first signaling indicates implicitly a number of layers of the first signal.

In one embodiment, the first signaling includes a second field, and the second field in the first signaling indicates a number of layers of the first signal.

In one embodiment, the second field includes a positive integer number of bits.

In one embodiment, the second field includes information in an Antenna port(s) field.

In one embodiment, the second field in the first signaling indicates a first DMRS port set, the first DMRS port set is used for transmitting a DMRS of the first signal; a number of layers of the first signal is equal to a number of DMRS ports included in the first DMRS port set.

In one embodiment, a DCI format of the first signaling is used for determining a number of layers of the first signal.

In one embodiment, the first signaling indicates explicitly the first threshold.

In one embodiment, the first signaling indicates implicitly the first threshold.

In one embodiment, the first signaling indicates an MCS corresponding to the first signal from a first MCS table, and the first MCS table is used for determining the first threshold.

In one embodiment, at least one of a DCI format of the first signaling or a signaling identifier of the first signaling is used for determining the first MCS table.

In one embodiment, the first MCS table is configured through an RRC signaling.

### Embodiment 29

Embodiment 29 illustrates a diagram of a scenario in which a first signal is spatially correlated to a first reference signal subgroup according to one embodiment of the disclosure, as shown in FIG. 29.

In one embodiment, the first reference signal subgroup includes a CSI-RS.

In one embodiment, the first reference signal subgroup includes an SSB.

In one embodiment, the first reference signal subgroup includes an SRS.

In one embodiment, the first reference signal subgroup is the first reference signal group.

In one embodiment, the first reference signal subgroup includes part reference signals in the first reference signal group only.

In one embodiment, the first reference signal subgroup includes one reference signal only.

In one embodiment, the first reference signal subgroup includes a positive integer number (greater than 1) of reference signals.

In one embodiment, any one reference signal in the first reference signal subgroup belongs to the first reference signal group.

In one embodiment, any one reference signal in the first reference signal subgroup is a CSI-RS or SSB.

In one embodiment, any two reference signals in the first reference signal subgroup cannot be assumed to be QCLed.

In one embodiment, any two reference signals in the first reference signal subgroup cannot be assumed to be QCLed or correspond to a QCL-TypeD.

In one embodiment, two reference signals in the first reference signal subgroup are QCLed.

In one embodiment, two reference signals in the first reference signal subgroup are QCLed and correspond to a QCL-TypeD.

In one embodiment, the first signaling indicates the first reference signal subgroup.

In one embodiment, the first signaling indicates explicitly the first reference signal subgroup.

In one embodiment, the first signaling indicates implicitly the first reference signal subgroup.

In one embodiment, the first signaling includes a third field, and the third field in the first signaling indicates the first reference signal subgroup.

In one embodiment, the third field includes a positive integer number of bits.

In one embodiment, the third field includes three bits.

In one embodiment, the third field includes information in a Transmission configuration indication field.

In one embodiment, the third field indicates a Transmission Configuration Indicator (TCI).

In one embodiment, the third field in the first signaling indicates a first TCI, and the first reference signal subgroup includes one reference signal only; and the first TCI indicates the one first reference signal.

In one embodiment, the third field in the first signaling indicates a TCI codepoint corresponding to the first TCI.

In one embodiment, the third field in the first signaling indicates M TCIs, and the first reference signal subgroup includes M reference signals; the M TCIs indicate the M reference signals respectively.

In one embodiment, the M TCIs correspond to one same TCI codepoint, and the third field in the first signaling indicates a TCI codepoint corresponding to the M TCIs.

In one embodiment, a DCI format of the first signaling is used for determining the first reference signal subgroup.

In one embodiment, a TCI state corresponding to the first signaling indicates the first reference signal subgroup.

In one embodiment, the phrase that the first signal is spatially correlated to a first reference signal subgroup includes: the first reference signal subgroup includes one reference signal only, and the first signal is spatially correlated to the first reference signal.

In one embodiment, the phrase that the first signal is spatially correlated to a first reference signal subgroup includes: the first reference signal subgroup includes M reference signals, the first signal includes M sub-signals, and the M is a positive integer greater than 1; and the M sub-signals are spatially correlated to the M reference signals respectively.

In one subembodiment, any two of the M sub-signals have a same number of layers.

In one subembodiment, two of the M sub-signals have different number of layers.

In one subembodiment, the M sub-signals occupy same time-frequency resources.

In one subembodiment, the M sub-signals are pairwise orthogonal in time domain.

In one subembodiment, the M sub-signals are pairwise orthogonal in frequency domain.

In one embodiment, the first node obtains a channel measurement used for calculating the first channel quality only based on the first reference signal subgroup before the first reference resource block.

In one embodiment, the first node obtains a channel measurement used for calculating the first channel quality only based on a nearest first reference signal subgroup before the first reference resource block.

In one embodiment, the first channel quality is uncorrelated to any one reference signal in the first reference signal group that does not belong to the first reference signal subgroup.

In one embodiment, the first channel quality is uncorrelated to any one reference signal in the first reference signal group other than the first reference signal subgroup.

In one embodiment, the first channel quality is calculated under the condition of the first rank number and the first reference signal subgroup.

### Embodiment 30

Embodiment 30 illustrates a diagram of a scenario in which a first channel quality is calculated under the condition of a first reference signal subgroup according to one embodiment of the disclosure, as shown in FIG. 30. In Embodiment 30, a given signal is a radio signal carrying the first bit block and is transmitted in the first reference resource block, or a given signal is a radio signal carrying the first bit block and transmitted in any one of the M reference resource subblocks; the given reference signal is one reference signal in the first reference signal subgroup.

In one embodiment, the first reference signal subgroup includes one reference signal only, the given signal is a radio signal carrying the first bit block and transmitted in the first reference resource block, and the given reference signal is the first reference signal.

In one embodiment, the first reference signal subgroup includes M reference signals, the given signal is a radio signal carrying the first bit block and transmitted in any one of M reference resource subblocks, and the given reference signal is a first reference signal among the M reference signals that is corresponding to the given reference resource subblock.

In one embodiment, the phrase that the first channel quality is calculated under the condition of the first reference signal subgroup includes: the first node calculates the first channel quality under the condition of assuming that the given signal is spatially correlated to the given reference signal.

In one embodiment, the phrase that the first channel quality is calculated under the condition of the first reference signal subgroup includes: the first node assumes that any one DMRS port of the given signal is QCLed with the given reference signal and calculates the first channel quality under such assumption.

In one embodiment, the phrase that the first channel quality is calculated under the condition of the first reference signal subgroup includes: the first node assumes that any one DMRS port of the given signal is QCLed with the given reference signal and corresponds to a QCL-TypeD, and calculates the first channel quality under such assumption.

In one embodiment, the phrase that the first channel quality is calculated under the condition of the first reference signal subgroup includes: the first node assumes that the given signal and the given reference signal are received using a same spatial domain filter, and calculates the first channel quality under such assumption.

In one embodiment, the first condition set includes: any one DMRS port of the given signal is QCLed with the given reference signal.

In one embodiment, the first condition set includes: any one DMRS port of the given signal is QCLed with the given reference signal and corresponds to a QCL-TypeD.

In one embodiment, the first condition set includes: the first node receives the given signal and the given reference signal using a same spatial domain filter.

In one embodiment, the given reference signal includes S reference signal ports, and the S is a positive integer; the phrase that the first channel quality is calculated under the condition of the first reference signal subgroup includes: the first node calculates the first channel quality under the following assumption: the given signal is transmitted on S1 layers, the S1 is a positive integer not greater than the S, and the S1 has a value equal to the first rank number; transmitting antenna ports of the S1 layers are S1 reference signal ports among the S reference signal ports respectively.

In one subembodiment, for any one given layer among the S1 layers, a channel experienced by a reference signal transmitted by a reference signal port corresponding to the given layer can deduce a channel experienced by the given layer.

In one embodiment, the S is equal to 1.

In one embodiment, the S is greater than 1.

In one embodiment, the S1 is equal to the S.

In one embodiment, the S1 is less than the S.

In one embodiment, for any one given value of the S1, positions of the S1 reference signal ports in the S reference signal ports are a default.

In one embodiment, the S reference signal ports are sequentially indexed.

In one embodiment, for any one given value of the S1, indexes of the S1 reference signal ports in the S reference signal ports are a default.

In one embodiment, the S1 reference signal ports are S reference signal ports with minimum indexes among the S reference signal ports.

In one embodiment, the S1 reference signal ports are S reference signal ports with maximum indexes among the S reference signal ports.

In one embodiment, an index of a reference signal port corresponding to any one of the S1 layers in the S reference signal ports is configured through an RRC signaling.

In one embodiment, the first condition set includes: the given signal is transmitted on the S1 layers, and transmitting antenna ports of the S1 layers are S1 reference signal ports among the S reference signal ports respectively.

In one embodiment, the first condition set includes: for any one given layer among the S1 layers, a channel experienced by a reference signal transmitted by a reference signal port corresponding to the given layer can deduce a channel experienced by the given layer.

In one embodiment, a channel experienced by a radio signal transmitted by one antenna port can deduce a channel experienced by another radio signal transmitted by the antenna port.

In one embodiment, a channel experienced by a radio signal transmitted by one antenna port cannot deduce a channel experienced by radio signal transmitted by another antenna port.

### Embodiment 31

Embodiment 31 illustrates a diagram of a scenario in which a given signal is spatially correlated to a given reference signal according to one embodiment of the disclosure, as shown in FIG. 31. In Embodiment 31, the given signal is one of the first signal, any one of the M sub-signals, a radio signal carrying the first bit block and transmitted in the first reference resource block, or a signal carrying the first bit block and transmitted in any one of the M reference resource sub-blocks; and the given reference signal is one reference signal in the first reference signal subgroup.

In one embodiment, the first reference signal subgroup includes one reference signal only, the given signal is the first signal, and the given reference signal is the one reference signal.

In one embodiment, the first reference signal subgroup includes M reference signals, the first signal includes M sub-signals, and the M sub-signals are spatially correlated to the M reference signals respectively; the given signal is any one of the M sub-signals, and the given reference signal is a reference signal among the M reference signals that is spatially correlated to the given signal.

In one embodiment, the first reference signal subgroup includes one reference signal only, the given signal is a radio signal carrying the first bit block and transmitted in the first reference resource block, and the given reference signal is the one first reference signal.

In one embodiment, the first reference signal subgroup includes M reference signals, the given signal is a radio signal carrying the first bit block and transmitted in any one of M reference resource subblocks, and the given reference signal is a first reference signal among the M reference signals that is corresponding to the given reference resource subblock.

In one embodiment, the spatial correlation includes QCL.

In one embodiment, the spatial correlation includes QCL and corresponds to a QCL-TypeA.

In one embodiment, the spatial correlation includes QCL and corresponds to a QCL-TypeB.

In one embodiment, the spatial correlation includes QCL and corresponds to a QCL-TypeC.

In one embodiment, the spatial correlation includes QCL and corresponds to a QCL-TypeD.

In one embodiment, the phrase that a given signal is spatially correlated to a given reference signal includes: a TCI state corresponding to the given signal indicates the given reference signal.

In one embodiment, the phrase that a given signal is spatially correlated to a given reference signal includes: a DMRS port of the given signal is QCLed with the given reference signal.

In one embodiment, the phrase that a given signal is spatially correlated to a given reference signal includes: a DMRS port of the given signal is QCLed with the given reference signal and corresponds to a QCL-TypeD.

In one embodiment, the phrase that a given signal is spatially correlated to a given reference signal includes: a DMRS port of the given signal is QCLed with the given reference signal and corresponds to a QCL-Type A.

In one embodiment, the phrase that a given signal is spatially correlated to a given reference signal includes: the given reference signal is used for determining large-scale properties of a channel experienced by the given signal.

In one embodiment, the phrase that a given signal is spatially correlated to a given reference signal includes: large-scale properties of a channel experienced by the given reference signal can deduce large-scale properties of a channel experienced by the given signal.

In one embodiment, the large-scale properties include one or more of a delay spread, a Doppler spread, a Doppler shift, an average delay or a spatial Rx parameter.

In one embodiment, the phrase that a given signal is spatially correlated to a given reference signal includes: the given reference signal is used for determining a spatial domain filter corresponding to the given signal.

In one embodiment, the phrase that a given signal is spatially correlated to a given reference signal includes: the first node receives the given reference signal and the given signal using a same spatial domain filter.

In one embodiment, the phrase that a given signal is spatially correlated to a given reference signal includes: a transmitting antenna port of the given reference signal is used for determining a transmitting antenna port of the given signal.

In one embodiment, the phrase that a given signal is spatially correlated to a given reference signal includes: the given signal and the given reference signal are transmitted by a same antenna port.

### Embodiment 32

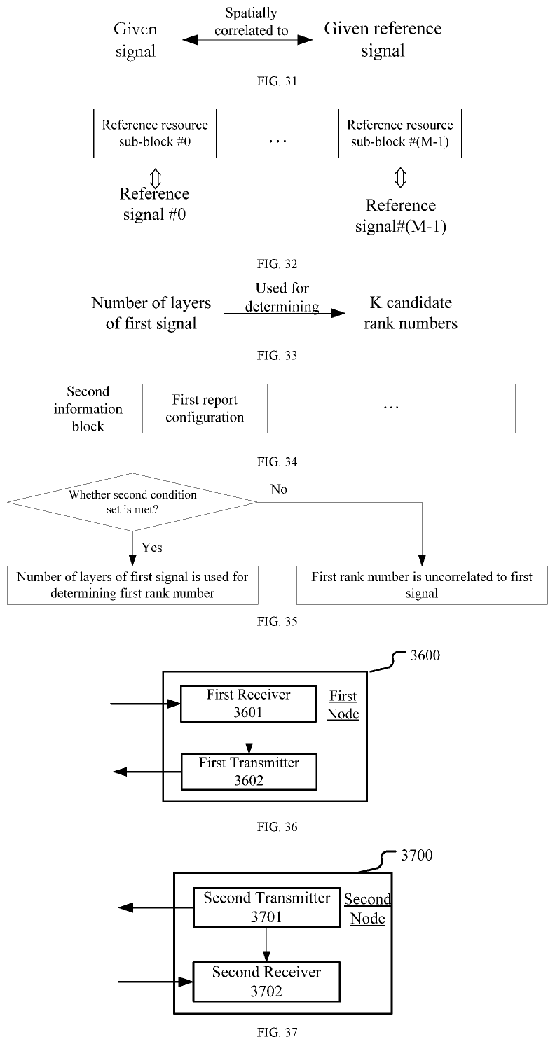

Embodiment 32 illustrates a diagram of M reference resource subblocks and M reference signals according to one embodiment of the disclosure, as shown in FIG. 32. In Embodiment 32, the first reference signal subgroup includes the M reference signals, the first reference resource block includes the M reference resource subblocks, and the M reference resource subblocks are one-to-one corresponding to the M reference signals. In FIG. 32, the M reference resource subblocks and the M reference signals are indexed with #0, . . . , #(M−1) respectively.

In one embodiment, the M reference signals include a CSI-RS.

In one embodiment, the M reference signals include an SSB.

In one embodiment, any one of the M reference signals is a CSI-RB or SSB.

In one embodiment, any two of the M reference signals cannot be assumed to be QCLed.

In one embodiment, any two of the M reference signals cannot be assumed to be QCLed or correspond to a QCL-TypeD.

In one embodiment, two of the M reference signals are QCLed.

In one embodiment, any two of the M reference resource subblocks occupy same time-frequency resources.

In one embodiment, the M reference resource subblocks are pairwise orthogonal in time domain.

In one embodiment, the M reference resource subblocks are pairwise orthogonal in frequency domain.

In one embodiment, the phrase that a first bit block occupies a first reference resource block includes: the first bit block occupies each of the M reference resource subblocks.

In one embodiment, the phrase that a first bit block occupies a first reference resource block includes:

the first bit block is repeatedly transmitted M times in the M reference resource subblocks respectively.

In one embodiment, any two of the M reference resource subblocks occupy same frequency domain resources.

In one embodiment, any two of the M reference resource subblocks occupy same time domain resources.

In one embodiment, the M is greater than 2.

In one embodiment, the M is equal to 2.

In one embodiment, the first signaling indicates the M.

In one embodiment, the third field in the first signaling indicates the M.

In one embodiment, the first reference signal group is composed of M reference signals.

In one embodiment, the first reference signal group includes at least one reference signal other than the M reference signals.

### Embodiment 33

Embodiment 33 illustrates a diagram of a scenario in which a number of layers of a first signal is used for determining K candidate rank numbers according to one embodiment of the disclosure, as shown in FIG. 33.

In one embodiment, a number of layers of the first signal is used by the first node to determine K candidate rank numbers.

In one embodiment, the K candidate rank numbers are K positive integers respectively.

In one embodiment, the K candidate rank numbers are not equal to each other.

In one embodiment, any one of the K candidate rank numbers is not greater than a number of layers of the first signal.

In one embodiment, any one of the K candidate rank numbers is not less than a number of layers of the first signal.

In one embodiment, any one of the K candidate rank numbers is not greater than a maximum number of layers corresponding to the first node.

In one embodiment, the K candidate rank numbers is composed of 1 to a number of layers of the first signal.

In one embodiment, the K candidate rank numbers are composed of a number of layers of the first signal to a maximum number of layers corresponding to the first node.

In one embodiment, an absolute value of a difference value between any one of the K candidate rank numbers and a number of layers of the first signal is not greater than a second threshold.

In one embodiment, the K candidate rank numbers are composed of all positive integers for which an absolute value of a difference value to a number of layers of the first signal is not greater than a second threshold and which are not greater than a maximum number of layers corresponding to the first node.

In one embodiment, the second threshold is a positive integer.

In one embodiment, the second threshold is configured through an RRC signaling.

In one embodiment, the first report configuration indicates the second threshold.

In one embodiment, the second threshold is correlated to a maximum number of layers corresponding to the first node.

In one embodiment, the second threshold is correlated to a maximum number of layers of downlink transmission corresponding to the first node.

In one embodiment, the second threshold is equal to a rounded product of a maximum number of layers corresponding to the first node and a first coefficient, and the first coefficient is a positive real number less than 1.

In one embodiment, the first information block indicates the first rank number from the K candidate rank numbers.

### Embodiment 34

Embodiment 34 illustrates a diagram of a second information block according to one embodiment of the disclosure, as shown in FIG. 34. In Embodiment 34, the second information block includes the first report configuration.

In one embodiment, the second information block is carried by a higher layer signaling.

In one embodiment, the second information block is carried by an RRC signaling.

In one embodiment, the second information block is carried by an MAC CE signaling.

In one embodiment, the second information block is carried by both an RRC signaling and an MAC CE signaling.

In one embodiment, the second information block includes information in part or all fields in one IE.

In one embodiment, the second information block includes information in part or all fields in one CSI-ReportConfig IE.

In one embodiment, the first report configuration includes information in part or all fields in one IE.

In one embodiment, the first report configuration is one IE.

In one embodiment, the first report configuration includes information in part or all fields in one CSI-ReportConfig IE.

In one embodiment, the first report configuration is a CSI-ReportConfig IE.

In one embodiment, a name of the first report configuration includes a CSI.

In one embodiment, a name of the first report configuration includes a CSI-report.

In one embodiment, the first information block includes one time of reporting for the first report configuration.

In one embodiment, the first report configuration includes second sub-information, and the second sub-information in the first report configuration indicates the first report metric set.

In one embodiment, the second sub-information includes information in one or more fields in one IE.

In one embodiment, the second sub-information includes information in a reportQuantity field in a CSI-ReportConfig IE.

In one embodiment, the first report metric set includes one or more of CQI, RI, PMI, CRI, SSBRI, LI (Layer Indicator), L1 (Layer 1)-RSRP or L1-SINR.

In one embodiment, the first report metric set includes an RI.

In one embodiment, the first report metric set does not include an RI.

In one embodiment, the first report metric set includes a CRI.

In one embodiment, the first report metric set does not include a CRI.

In one embodiment, the first report metric set includes a PMI.

In one embodiment, the first report metric set does not include a PMI.

In one embodiment, the first report configuration includes third sub-information, and the third sub-information in the first report configuration indicates the first reference signal group.

In one embodiment, the third sub-information includes information in one or more fields in one IE.

In one embodiment, the third sub-information includes information in at least one of a resourcesForChannelMeasurement field, a csi-IM-ResourcesForInterference field or a nzp-CSI-RS-ResourcesForInterference field in a CSI-ReportConfig IE.

In one embodiment, the third sub-information in the first report configuration indicates all reference signals in the first reference signal group in sequence.

In one embodiment, the first report configuration indicates that one time of reporting for the first report metric set is obtained according to a channel measurement for the first reference signal group.

In one embodiment, the first report configuration indicates that one time of reporting for the first report metric set is obtained according to an interference measurement for the first reference signal group.

In one embodiment, the content of the first information block includes one or more of CQI, RI, PMI, CRI, SSBRI, LI, L1-RSRP or L1-SINR.

In one embodiment, the content of the first information block includes one time of reporting about each report metric in the first report metric set.

In one embodiment, the first report configuration indicates that the first channel quality is calculated under the condition that the rank number is equal to a number of layers of the first signal.

### Embodiment 35

Embodiment 35 illustrates a diagram of a relationship between a second condition set and a first rank number according to one embodiment of the disclosure, as shown in FIG. 35. In Embodiment 35, a number of layers of the first signal is used for determining the first rank number when and only when the second condition set is met.

In one embodiment, the second condition set includes: a numerical value of a target interval belongs to a first numerical value set, and the first numerical value set includes a positive integer number of positive integers.

In one subembodiment, the first numerical value set is configured through an RRC signaling.

In one embodiment, the second condition set includes: a unit of the target interval belongs to a first unit set, the first unit set includes one or more of one slot, one sub-slot, P1 multicarrier symbols, or one multicarrier symbol; and P1 is a positive integer greater than 1.

In one subembodiment, the first unit set is configured through an RRC signaling.

In one embodiment, the target interval is a time interval between the first information block and the first signal.

In one embodiment, the target interval is a time interval between a start time of a time unit occupied by the first information block and a start time of a time unit occupied by the first signal.

In one embodiment, the target interval is a time interval between the first signaling and the first signal.

In one embodiment, the target interval is a time interval between a start time of a time unit occupied by the first signaling and a start time of a time unit occupied by the first signal.

In one embodiment, the target interval is a time interval between a latest reference signal in the first reference signal group and the first information block.

In one embodiment, the target interval is a time interval between a start time of a time unit occupied by a latest reference signal in the first reference signal group and a start time of a time unit occupied by the first information block.

In one embodiment, the target interval is a time interval between a latest reference signal in the first reference signal subgroup and the first information block.

In one embodiment, the target interval is a time interval between a start time of a time unit occupied by a latest reference signal in the first reference signal subgroup and a start time of a time unit occupied by the first information block.

In one embodiment, a unit of the target interval is one of one slot, one sub-slot, P1 multicarrier symbols, or one multicarrier symbol; and P1 is a positive integer greater than 1.

In one embodiment, a unit of the target interval is the time unit.

In one embodiment, the P1 is configured through an RRC signaling.

In one embodiment, the second condition set includes: a DCI format of the first signaling belongs to a first format set; the first format set includes one or more of a DCI Format 1_0, a DCI Format 1_1 or a DCI Format 1_2.

In one subembodiment, the first format set is configured through an RRC signaling.

In one embodiment, the second condition set includes: the first signaling includes a DCI for downlink grant.

In one embodiment, the second condition set includes: a signaling identifier of the first signaling belongs to a first identifier set; the first identifier set includes one or more of a Cell-Radio Network Temporary Identifier (C-RNTI), a Configured Scheduling-RNTI (CS-RNTI), an MCS-C-RNTI or SP-CSI-RNTI.

In one subembodiment, the first identifier set is configured through an RRC signaling.

In one embodiment, the second condition set includes: a priority index of the first signal is equal to 1.

In one embodiment, the first signaling indicates an MCS of the first signal from a first MCS table; the second condition set includes: the first MCS table belongs to a first MCS table set.

In one subembodiment, the first MCS table set is configured through an RRC signaling.

In one embodiment, the second condition set includes: the first report metric set does not include an RI.

In one embodiment, when the second condition set is not met, the first rank number is uncorrelated to a number of layers of the first signal.

### Embodiment 36

Embodiment 36 illustrates a structure block diagram of a processing device in a first node according to one embodiment of the disclosure, as shown in FIG. 36. In FIG. 36, the processing device 3600 in the first node includes a first receiver 3601 and a first transmitter 3602.

In Embodiment 36, the first receiver 3601 receives a first signal, and receives a first reference signal group in a first reference signal resource group; and the first transmitter 3602 transmits a first information block.

In Embodiment 36, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the first node with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the first receiver 3601 receives a first signaling, the first signaling includes scheduling information of the first signal, and the first signaling triggers the transmission of the first information block; the first signaling indicates the number of layers of the first signal.

In one embodiment, the first signal is spatially correlated to a first reference signal subgroup, the first reference signal subgroup is a subset of the first reference signal group; and the first channel quality is calculated under the condition of the first reference signal subgroup.

In one embodiment, the first reference signal subgroup includes M reference signals, and the M is a positive integer greater than 1; the first reference resource block includes M reference resource subblocks, and the M reference resource subblocks are one-to-one corresponding to the M reference signals.

In one embodiment, the number of layers of the first signal is used for determining K candidate rank numbers, and the K is a positive integer greater than 1; the first rank number is one of the K candidate rank numbers.

In one embodiment, the first receiver 3601 receives a second information block, wherein the second information block include a first report configuration, the first report configuration indicates a first report metric set and the first reference signal group, and the first report metric set is used for determining the content of the first information block.

In one embodiment, the number of layers of the first signal is used for determining the first rank number when and only when the second condition set is met.

In one embodiment, the first node is a UE.

In one embodiment, the first node is a relay node.

In one embodiment, the first receiver 3601 includes at least one of the antenna 452, the receiver 454, the receiving processor 456, the multiantenna receiving processor 458, the controller/processor 459, the memory 460 or the data source 467.

In one embodiment, the first transmitter 3602 includes at least one of the antenna 452, the transmitter 454, the transmitting processor 468, the multiantenna transmitting processor 457, the controller/processor 459, the memory 460 or the data source 467.

### Embodiment 37

Embodiment 37 illustrates a structure block diagram of a processing device in a second node according to one embodiment of the disclosure, as shown in FIG. 37. In FIG. 37, the processing device 3700 in the second node includes a second transmitter 3701 and a second receiver 3702.

In Embodiment 37, the second transmitter 3701 transmits a first signal, and transmits a first reference signal group in a first reference signal resource group; and the second receiver 3702 receives a first information block.

In Embodiment 37, a measurement for the first reference signal group is used for generating the first information block, and the first information block includes a first channel quality; a number of layers of the first signal is used for determining a first rank number, and the first channel quality is calculated under the condition of the first rank number; the first channel quality indicates: when a first bit block occupies a first reference resource block and a first condition set is met, the first bit block can be received by the transmitter of the first information block with a transmission block error rate not exceeding a first threshold; the first condition set includes: the first bit block employs a transmission mode corresponding to the first channel quality; the transmission mode corresponding to the first channel quality includes one or more of a modulation scheme, a code rate or a transmission block size; a time domain position of the first reference resource block is associated to a time domain resource occupied by the first information block.

In one embodiment, the second transmitter 3701 transmits a first signaling, wherein the first signaling includes scheduling information of the first signal, and the first signaling triggers the transmission of the first information block; the first signaling indicates the number of layers of the first signal.

In one embodiment, the first signal is spatially correlated to a first reference signal subgroup, the first reference signal subgroup is a subset of the first reference signal group; and the first channel quality is calculated under the condition of the first reference signal subgroup.

In one embodiment, the first reference signal subgroup includes M reference signals, and the M is a positive integer greater than 1; the first reference resource block includes M reference resource subblocks, and the M reference resource subblocks are one-to-one corresponding to the M reference signals.

In one embodiment, the number of layers of the first signal is used for determining K candidate rank numbers, and the K is a positive integer greater than 1; the first rank number is one of the K candidate rank numbers.

In one embodiment, the second transmitter 3701 transmits a second information block, wherein the second information block include a first report configuration, the first report configuration indicates a first report metric set and the first reference signal group, and the first report metric set is used for determining the content of the first information block.

In one embodiment, the number of layers of the first signal is used for determining the first rank number when and only when the second condition set is met.

In one embodiment, the second node is a base station.

In one embodiment, the second node is a UE.

In one embodiment, the second node is a relay node.

In one embodiment, the second transmitter 3701 includes at least one of the antenna 420, the transmitter 418, the transmitting processor 416, the multiantenna transmitting processor 471, the controller/processor 475 or the memory 476.

In one embodiment, the second receiver 3702 includes at least one of the antenna 420, the receiver 418, the receiving processor 470, the multiantenna receiving processor 472, the controller/processor 475 or the memory 476.

The ordinary skill in the art may understand that all or part steps in the above method may be implemented by instructing related hardware through a program. The program may be stored in a computer readable storage medium, for example Read-Only Memory (ROM), hard disk or compact disc, etc. Optionally, all or part steps in the above embodiments also may be implemented by one or more integrated circuits. Correspondingly, each module unit in the above embodiment may be realized in the form of hardware, or in the form of software function modules. The disclosure is not limited to any combination of hardware and software in specific forms. The UE and terminal in the disclosure include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, REID terminals, NB-IOT terminals, Machine Type Communication (MTC) terminals, enhanced MTC (eMTC) terminals, data cards, low-cost mobile phones, low-cost tablet computers, and other radio communication equipment. The base station or system in the disclosure includes but not limited to macro-cellular base stations, micro-cellular base stations, home base stations, relay base station, gNBs (NR nodes B), NR nodes B, Transmitter Receiver Points (TRPs), and other radio communication equipment.

The above are merely the preferred embodiments of the disclosure and are not intended to limit the scope of protection of the disclosure. Any modification, equivalent substitute and improvement made within the spirit and principle of the disclosure are intended to be included within the scope of protection of the disclosure.

What is claimed is:

1. A first node for wireless communication, comprising:
a first receiver, to receive a first signaling and a second signaling, the first signaling being used for determining a first air interface resource block and a first bit block, the second signaling being used for determining K air interface resource blocks, and the K being a positive integer greater than 2; and
a first transmitter, to transmit K signals in the K air interface resource blocks respectively, the K air interface resource blocks are pairwise orthogonal in time domain;
wherein the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset comprise at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

2. The first node according to claim 1, wherein the first receiver receives a third signal, the first signaling is used for determining configuration information of the third signal, and the third signal is used for determining the first bit block.

3. The first node according to claim 1, wherein the first reference signal and the second reference signal correspond to a same TCI codepoint.

4. The first node according to claim 1, wherein the first signal comprises a first sub-signal, and the first sub-signal carries the first bit block; the second signal comprises a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

5. The first node according to claim 1, wherein a time interval between an earliest air interface resource block among the K air interface resource blocks and the first signaling is not less than a first interval; the first interval is correlated to a subcarrier spacing corresponding to the first air interface resource block.

6. A second node for wireless communication, comprising:
a second transmitter, to transmit a first signaling and a second signaling, the first signaling being used for determining a first air interface resource block and a first bit block, the second signaling being used for determining K air interface resource blocks, and the K being a positive integer greater than 2; and
a second receiver, to receive K signals in the K air interface resource blocks respectively, the K air interface resource blocks are pairwise orthogonal in time domain;
wherein the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset comprise at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

7. The second node according to claim 6, wherein the second transmitter transmits a third signal, the first signaling is used for determining configuration information of the third signal, and the third signal is used for determining the first bit block.

8. The second node according to claim 6, wherein the first reference signal and the second reference signal correspond to a same TCI codepoint.

9. The second node according to claim 6, wherein the first signal comprises a first sub-signal, and the first sub-signal carries the first bit block; the second signal comprises a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

10. The second node according to claim 6, wherein a time interval between an earliest air interface resource block among the K air interface resource blocks and the first signaling is not less than a first interval; the first interval is correlated to a subcarrier spacing corresponding to the first air interface resource block.

11. A method in a first node for wireless communication, comprising:
receiving a first signaling, the first signaling being used for determining a first air interface resource block and a first bit block;
receiving a second signaling, the second signaling being used for determining K air interface resource blocks, and the K being a positive integer greater than 2; and
transmitting K signals in the K air interface resource blocks respectively, the K air interface resource blocks are pairwise orthogonal in time domain;
wherein the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset comprise at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

12. The method according to claim 11, comprising:
receiving a third signal;
wherein the first signaling is used for determining configuration information of the third signal, and the third signal is used for determining the first bit block.

13. The method according to claim 11, wherein the first reference signal and the second reference signal correspond to a same TCI codepoint.

14. The method according to claim 11, wherein the first signal comprises a first sub-signal, and the first sub-signal carries the first bit block; the second signal comprises a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

15. The method according to claim 11, wherein a time interval between an earliest air interface resource block among the K air interface resource blocks and the first signaling is not less than a first interval; the first interval is correlated to a subcarrier spacing corresponding to the first air interface resource block.

16. A method in a second node for wireless communication, comprising:
transmitting a first signaling, the first signaling being used for determining a first air interface resource block and a first bit block;
transmitting a second signaling, the second signaling being used for determining K air interface resource blocks, and the K being a positive integer greater than 2; and
receiving K signals in the K air interface resource blocks respectively, the K air interface resource blocks are pairwise orthogonal in time domain;
wherein the first air interface resource block and any one of the K air interface resource blocks are overlapping in time domain; the K signals all carry a second bit block; a first signal subset is spatially correlated to a first reference signal, and a second signal subset is spatially correlated to a second reference signal; the first signal subset and the second signal subset comprise at least one signal among the K signals respectively, the first reference signal and the second reference signal cannot be assumed to be quasi-co-located; only a first signal and a second signal among the K signals carry the first bit block; the first signal is a first signal in the first signal subset, and the second signal is a first signal in the second signal subset.

17. The method according to claim 16, comprising:
transmitting a third signal;
wherein the first signaling is used for determining configuration information of the third signal, and the third signal is used for determining the first bit block.

18. The method according to claim 16, wherein the first reference signal and the second reference signal correspond to a same TCI codepoint.

19. The method according to claim 16, wherein the first signal comprises a first sub-signal, and the first sub-signal carries the first bit block; the second signal comprises a second sub-signal, and the second sub-signal carries the first bit block; the second signaling indicates a target integer, and a number of multicarrier symbols occupied by any one of the K air interfaces resource blocks is not greater than the target integer; and the target integer is used for determining a number of resource elements occupied by the first sub-signal and a number of resource elements occupied by the second sub-signal.

20. The method according to claim 16, wherein a time interval between an earliest air interface resource block among the K air interface resource blocks and the first signaling is not less than a first interval; the first interval is correlated to a subcarrier spacing corresponding to the first air interface resource block.
